(19) United States
(12) Patent Application Publication
(10) Pub. No.: US 2026/0065456 A1
(43) Pub. Date: Mar. 5, 2026

(54) IDENTIFYING INSTALLATION ANOMALIES USING COMPUTER VISION

(71) Applicant: Nvidia Corporation, Santa Clara, CA (US)

(72) Inventors: Tao Hu, Shenzhen (CN); Zhong Tan, Shenzhen (CN); Dingfeng Wang, Shenzhen (CN); Huck Boon Soon, Penang (MY)

(21) Appl. No.: 18/893,102

(22) Filed: Sep. 23, 2024

(30) Foreign Application Priority Data
Aug. 27, 2024 (WO) PCT/CN2024/114904

(51) Int. Cl. G06T 7/00; G06T 7/13; G06T 7/73

(52) U.S. Cl. CPC G06T 7/0004; G06T 7/13; G06T 7/73; G06T 2207/30141

(57) ABSTRACT

Approaches presented herein provide for the automatic inspection of material element having an expected size, shape, and location. Such automatic analysis can be useful for inspecting the installation of an element, such as a patch of thermal interface material (TIM) attached to a heat sink of a graphics card. A digital image can be captured and cropped to a region of interest including an element to be inspected. A contour of the element can be identified and used to determine the location of a first edge of the element. Test lines can be swept across the area of the contour until at least one edge criterion is satisfied for additional edges of the element. The intersections of these edges can be identified and used as approximations of the corners or vertexes of the element. The coordinates of these elements, or values calculated therefrom, can be compared to expected coordinates from a reference standard to determine whether the element satisfies one or more inspection criteria.

### CROSS-REFERENCE TO RELATED APPLICATIONS

This application claims priority to PCT Application Serial No. PCT/CN2024/114904 filed Aug. 27, 2024, and entitled “IDENTIFYING INSTALLATION ANOMALIES USING COMPUTER VISION,” which is hereby incorporated herein in its entirety and for all purposes.

### TECHNICAL FIELD

This disclosure generally relates to inspection of manufactured assemblies using computer vision and, in particular, to identifying installation anomalies of material elements on physical components using computer vision.

### BACKGROUND

In various assembly or installation operations, it can be desirable to verify that one or more components have been installed correctly, such as in the desired location and orientation within acceptable variation thresholds or ranges. For mass production lines, it can be desirable to perform such verification as quickly and efficiently as possible, in order to avoid slowing down the production line. In order to analyze aspects of an assembly, or assembled object, it can be useful to capture one or more images of the assembly and perform automated analysis of the image data, as visual inspections by a human will typically not be sufficiently reliable or robust. In many situations, however, traditional computer vision techniques will not be fast enough to allow for accurate use in a real-time production line. While the use of deep learning can help to improve the speed of such an image-based analysis, existing deep learning algorithms have an unacceptably large margin of error for at least certain production operations. Further, these models need a large amount of training data for each specific type of analysis and/or assembly, which can be costly to generate and maintain, in addition to the time and expense needed to train or fine-tune the models using this data.

### BRIEF DESCRIPTION OF THE DRAWINGS

Various embodiments in accordance with the present disclosure will be described with reference to the drawings, in which:

FIG. 1A illustrates a side view of a physical assembly that can be inspected, according to at least one embodiment;

FIG. 1B illustrates a top view of a portion of a physical assembly showing a material element to be inspected, according to at least one embodiment;

FIGS. 2A, 2B, 2C, 2D, 2E, 2F, 2G, 2H, and 2I illustrate stages of a coordinate determination process for an installed material element, according to at least one embodiment.

FIG. 3 illustrates an example system to perform an inspection of an installed material element, according to at least one embodiment.

FIG. 4A illustrates an example process that can be performed to determine corner coordinates for an installed material element, according to at least one embodiment.

FIG. 4B illustrates an example process that can be performed to determine vertex locations for an installed material element, according to at least one embodiment.

FIG. 5 illustrates an example data center system, according to at least one embodiment;

FIG. 6 is a block diagram illustrating a computer system, according to at least one embodiment;

FIG. 7 is a block diagram illustrating a computer system, according to at least one embodiment;

FIG. 8 illustrates a computer system, according to at least one embodiment;

FIG. 9 illustrates a computer system, according to at least one embodiment;

FIG. 10 illustrates exemplary integrated circuits and associated graphics processors, according to at least one embodiment;

FIGS. 11A, 11B illustrate exemplary integrated circuits and associated graphics processors, according to at least one embodiment;

FIG. 12 illustrates a computer system, according to at least one embodiment;

FIG. 13A illustrates a parallel processor, according to at least one embodiment;

FIG. 13B illustrates a partition unit, according to at least one embodiment;

FIG. 14 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous or autonomous vehicles or machines (e.g., in one or more advanced driver assistance systems (ADAS), one or more in-vehicle infotainment systems, one or more emergency vehicle detection systems), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, generative AI, model training or updating, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, generative AI, cloud computing, and/or any other suitable applications.

Disclosed embodiments may be comprised in a variety of different systems such as automotive systems (e.g., an in-vehicle infotainment system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), vision language models (VLMs), systems for performing generative AI operations (e.g., using one or more language models), systems for performing light transport simulation, systems for performing collaborative content creation for 3D assets, systems implemented at least partially using cloud computing resources, and/or other types of systems.

Approaches in accordance with various illustrative embodiments provide for automatic determination of values useful for inspection of an installed material element (or other such part or component), where that element has an expected size, shape, and/or location corresponding to proper installation. Such automatic analysis can be useful for inspecting the installation of a layer or patch of thermal interface material (TIM), for example, having an expected size, rectangular (e.g., square) shape, and placement, with respect to a heat sink of a graphics card or other such assembly or physical component. A digital image can be captured of an assembly that may show a number (e.g., 10) of installed elements. In order to evaluate these individual elements, the digital image can be cropped to generate a number (e.g., 10) of images that each includes a view of a respective element (e.g., respective TIM patch). The cropped images can be based at least in part upon the expected locations of the installed elements obtained from a golden standard or other such trusted reference. A (e.g., each) cropped image can be analyzed (e.g., by using OpenCV) to identify an outer contour of an element, and a voting (or other such) procedure can be used to identify a line corresponding to an edge of the element (using pixel values of the contour). The area within the contour can be filled so the working image becomes essentially a binary image of pixels within the element (e.g., with white values) and outside the element (e.g., with non-white values). In order to simplify the operation and improve efficiency, the image can be rotated by a determined angle so that the identified edge line is horizontal (or vertical, depending on the edge identified). A test line that is parallel to the first edge can be swept across the element, such as from a center position, in a direction orthogonally away from the first edge until an edge criterion is satisfied. An edge criterion might be that the number of white pixels intersected by the test line drops below a determined percentage (e.g., 50%) of the maximum number of white pixels encountered determined during the sweep. The third and fourth edges of a rectangular element, which will be orthogonal to the first and second edges, can be determined using a similar approach. For other shapes, other edges may be detected by sweeping from center in other appropriate directions. A test line (orthogonal to the first and second edges) can be swept in opposing directions (parallel to the first and second edge lines) until at least one corresponding edge criterion is satisfied. Once all edges are identified, their intersections can be identified as approximate vertices of the element. If an earlier rotation was performed, an opposite rotation can be performed (e.g., by rotating by theta degrees in the opposite direction) to obtain final positions/coordinates of the corners or vertices of the element. The locations of these vertices can be provided for comparison with a range or set of expected vertex positions, for example, to determine whether the installation of the material element falls within these expected ranges and successfully passes the inspection.

Variations of this and other such functionality can be used as well within the scope of the various embodiments as would be apparent to one of ordinary skill in the art in light of the teachings and suggestions contained herein.

In various physical assemblies, there is a need to ensure that the individual components, elements, or other portions of those assemblies are installed or formed correctly, at least within allowable variation or expectation. This can include ensuring that individual components are installed at the proper location with the proper orientation, as well as that the entire component was installed that has the intended size, shape, and/or other such aspects. While a manual inspection may be at least somewhat accurate for many such assemblies, the time needed for a manual inspection of each individual assembly may be prohibitive-particularly for mass production or assembly lines with minimum throughput targets. In order to be able to inspect individual assemblies without unacceptably slowing down the production line, it can be desirable to automate the inspection process for at least certain components or stages of assembly.

As mentioned, however, it can be difficult to automate the inspection of many types of assemblies in a way that satisfies both accuracy and timing constraints. For example, a deep learning-based approach using the model Faster-RCNN/YOLO was observed to have about a 2.5% probability of incorrectly detecting a component in an image, which can result in an unacceptable number of false alerts. Further, any time there is a change to a component or assembly, the need to generate sufficient training data and update the relevant model(s) can be expensive and time consuming. Existing computer vision algorithms, such as those that attempt to identify a geometric representation (e.g., a maximum inner rectangle) of a component, can take a significant amount of time (e.g., 1-3 seconds) to perform the analysis for each region of interest, presenting an O(n²) problem. In many instances, this amount of time will be longer than is acceptable for a mass production line. Further, an approximation such as a maximum inner triangle approximation will almost always return dimensions smaller than the actual component, which can result in incorrect determinations, particularly for edge cases.

Accordingly, approaches in accordance with various embodiments can use a sequence of geometric approximations to determine an oriented representation, such as an oriented bounding box or geometric boundary, for an element, component, part, layer, or other such object represented in captured image (or other such sensor) data. Such an approach presents an O(n)-type problem (rather than an O(n²)-type problem) which is significantly faster than prior computer vision-based approaches, and avoids the expense and complexity associated with deep learning-based approaches.

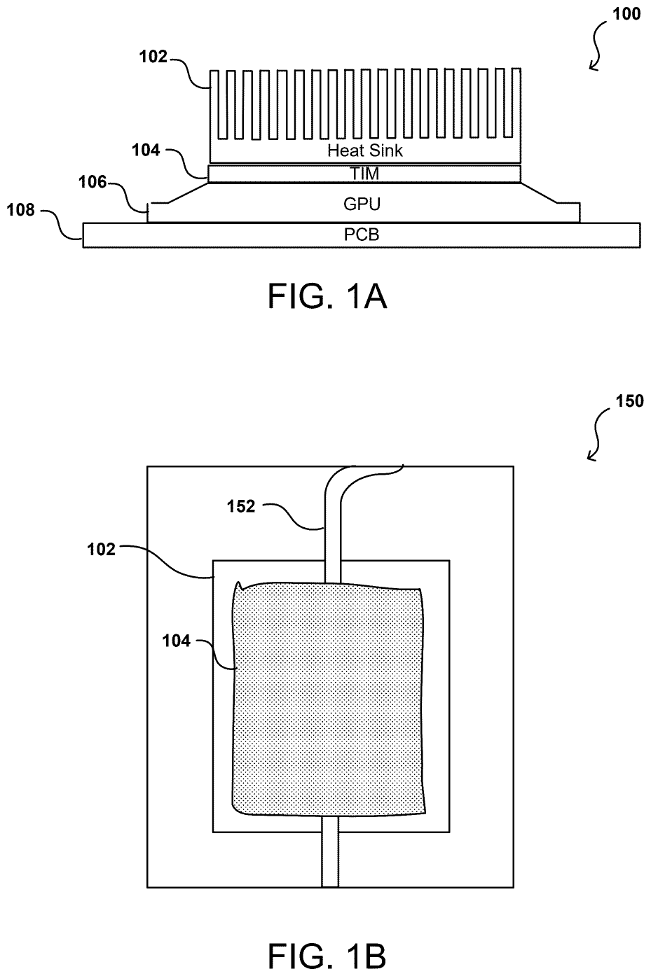

FIG. 1A illustrates an example assembly 100 that can be analyzed in accordance with at least one embodiment. In this example, the assembly includes a number of components positioned on a printed circuit board (PCB) 108. At least one graphics processing unit (GPU) 106 is positioned on the PCB 108 and connected to circuitry to allow data to be transmitted to and from the GPU 106. Components such as a GPU 106 may generate a significant amount of heat, and it may be desirable to remove or dissipate this heat to prevent performance (or other such) issues with the GPU 106 or related components. Accordingly, a heat sink 102 can be positioned relative to the GPU such that heat from the GPU 106 can be transferred to the heat sink 102 and then dissipated, such as by using a number of fins, or other elongated protrusions, to increase surface area from which heat can dissipate into nearby (and often circulating) medium such as air.

In many such assemblies, if a heat sink 102 were to be placed directly on top of (or otherwise adjacent to) a heat-generating component, such as a GPU 106 or chip, then a thin layer of air gaps will exist between the two mating surfaces. These gaps are a result of the imperfection and/or roughness of those surfaces. Such air gaps can function as thermal barriers to heat dissipation, reducing the ability for the heat sink 102 to efficiently remove heat from the GPU 106. Accordingly, many such assemblies will use a layer (e.g. a patch) of a thermal interface material (TIM) 104 between the heat sink 102 and the heat-generating component, which is the GPU 106 in this example. The TIM 104 can be used to remove or reduce the presence of air gaps, reducing the presence of these thermal barriers. The TIM 104 can be selected to have high thermal conductivity, in addition to the ability to fill in these micro air gaps, to allow for significant heat transfer from the GPU 106 to the heat sink 102. The TIM 104 can also be selected such that it will not degrade or present a reduction in these properties over time. Examples of thermal interface materials include thermal tapes, gap filler pads, thermal greases, phase change materials, thermal epoxies, gels, and solders, among other such options.

In the example assembly 100 of FIG. 1A, a layer of thermal tape is used to form a patch of TIM 104. Such a tape patch can include a thermally-conductive, double-sided adhesive tape that is able to hold the heat sink in place with respect to the GPU without a separate mechanical attachment, and maintain that attachment at high temperatures and through thermal cycling. Other TIM components or layers can be used as well, as may correspond to gap filler pads or elastomeric pads, among other such options. An example layer of TIM for such purposes can be approximately 0.25-2.0 mm in thickness, with a width and length corresponding to the heat sink 102 and GPU 106 to be thermally attached, such as may include ranges between 2.0 mm and 10.0 cm. In order to ensure at least a minimum amount of heat transfer, or an amount of heat transfer within a target range, the patch of TIM 104 to be used may be of a determined size and shape, such as may cover a determined percentage or area of the mating surfaces. The position of the TIM 104 may also be important to ensure sufficient attachment strength and thermal conductivity between those mating surfaces. Since the TIM 104 may be applied to at least one of the mating surfaces using an automated (or manual) process in a production line, it can be desirable to ensure that the TIM 104 does also not include an anomaly (e.g., irregular shape, etc.) that may result in variations in thermal conductivity across the dimensions (e.g., width, etc.) of the TIM 104. The TIM may be applied manually by a human operator or automatically by an automated mechanism, or a combination thereof.

In at least one embodiment, an optical inspection can occur after a patch of TIM 104 is placed on one of the mating surfaces, such as the mating surface of the heat sink 102. This may include, for example, capturing an image (e.g., top-down image) of at least the mating surface of the heat sink 102 and one or more TIMs including the TIM 104, as well as any other portions of the PCB assembly assembled thus far. In order to ensure analysis of the appropriate components, the image can be cropped (if necessary) to produce an image 150 that includes a region of interest (ROI) about a particular TIM such as the TIM 104, as illustrated in the top-down view of FIG. 1B. The location of the ROI can be determined through image analysis or another such approach. For example, the location of the ROI can be determined based on a “golden standard” or known perfect sample for the assembly, which would cause the TIM 104 to be located in a specific location and orientation in the cropped image 150. Such an approach can be fast and efficient, which can be important in a mass production environment. As illustrated, there may be at least portions of other components visible in the cropped image 150 as well, as may correspond to portions of the heat sink 102 and copper tubing 152, among other such possibilities. In at least one embodiment, a captured image can include a view of an entire mating side of a heat sink, and there may be a number (e.g., 10) of TIMs present across that mating side. In such an example, the process can generate 10 cropped images, each of which represents a region of interest around a respective TIM, allowing for separate analysis of the individual TIM patches on a given heat sink.

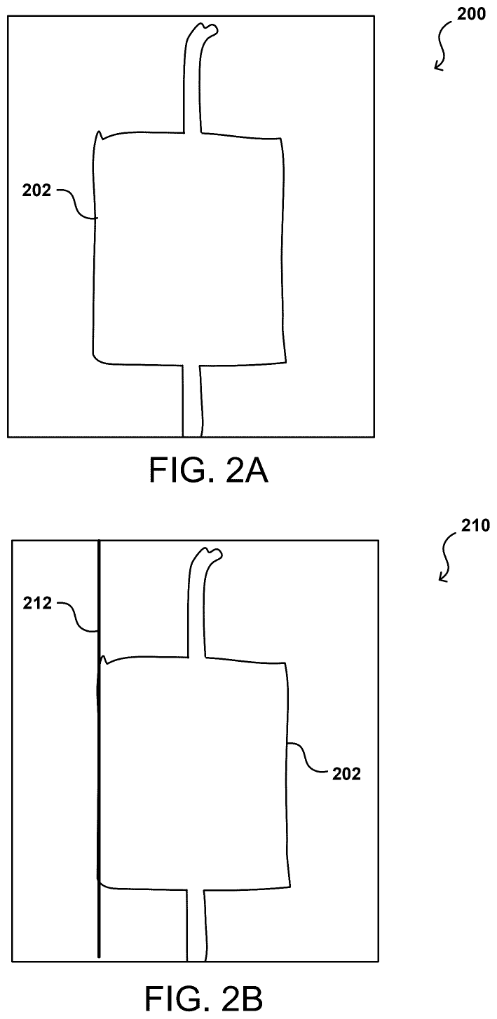

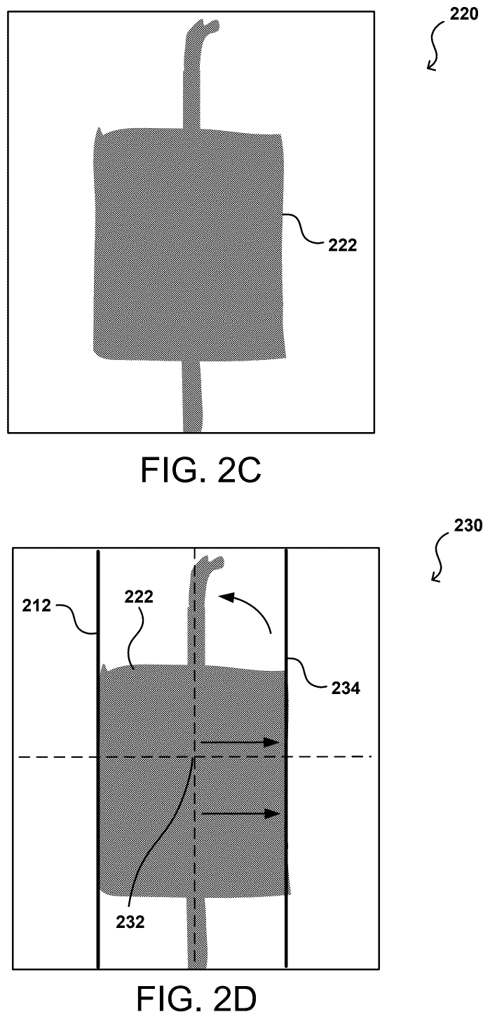

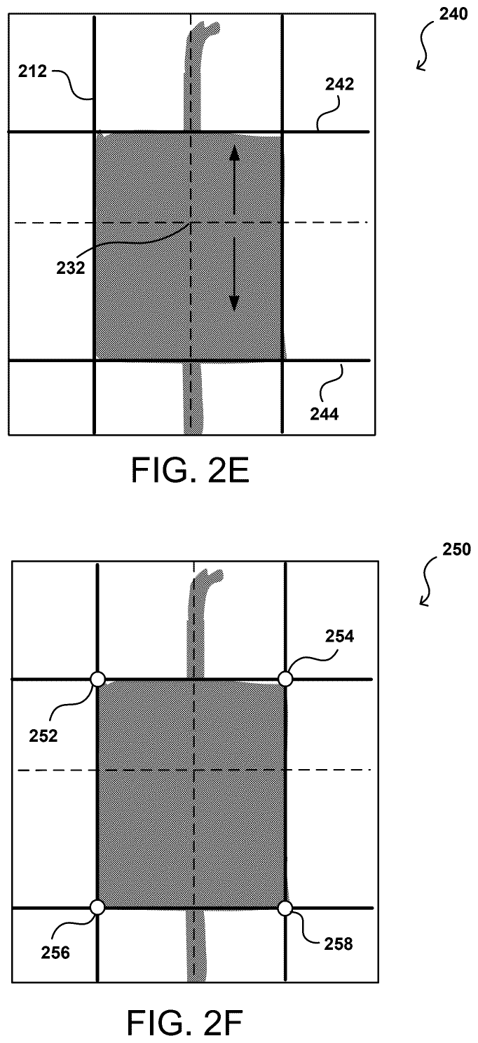

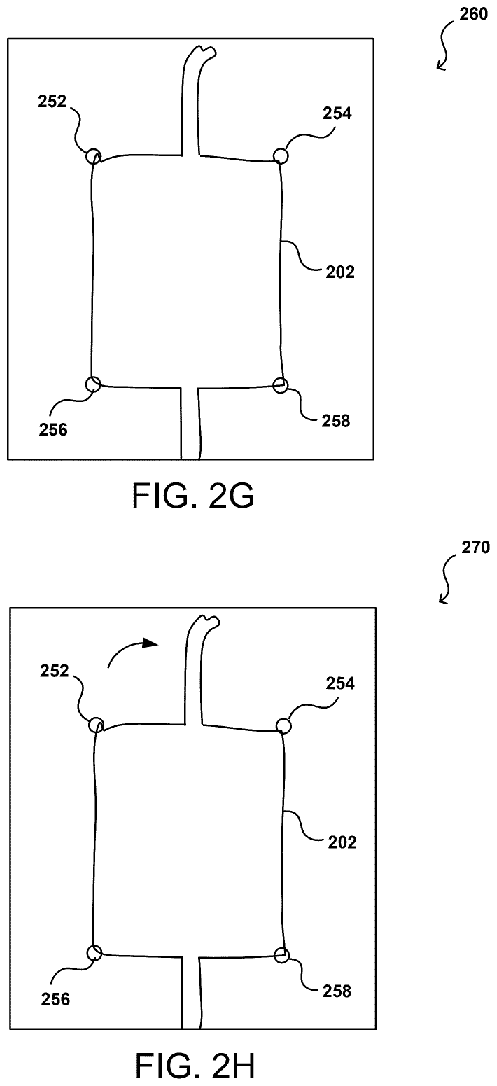

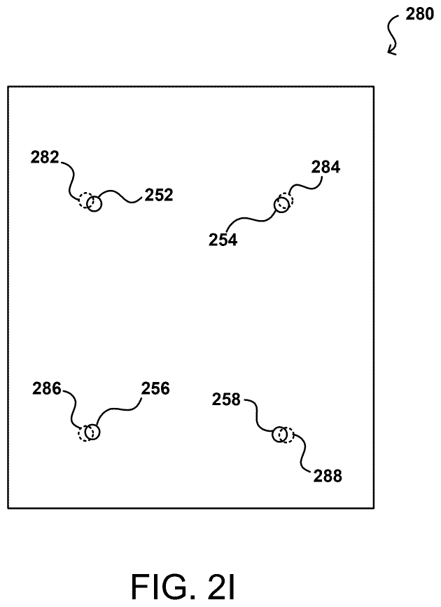

In at least one embodiment, it can be desirable to determine a contour of an element to be inspected, such as a TIM patch installed on a heat sink. A cropped image, such as cropped image 150 in FIG. 1B, can be analyzed to attempt to identify edges within the ROI. In one embodiment, the edges can be identified using a computer vision process, which may utilize the open source OpenCV library, such as by using OpenCV Blur+Canny to locate edges. These edges can be analyzed (such as by using OpenCV findContours or a contour-determination algorithm) to identify a maximum perimeter closed contour within the ROI. As illustrated in FIG. 2A, a maximum perimeter closed contour 202 may include some noise or additional component portions (e.g., a portion of the copper tubing 152). However, as long as the TIM patch represents the majority of the space contained within the contour 202, then the process can continue. In at least some embodiments, there may be at least one check performed on the contour 202 to ensure that the contour is approximately of the shape and size expected. For example, if a TIM patch is not present in the image, or if there is an obstruction in the image, then a significantly different contour may be generated; and, in response to the generation of the different contour, the process may generate an alert or failure at that point without performing further analysis, in order to conserve resources and time.

Once the contour 202 is obtained as illustrated in FIG. 2A, an attempt can be made to identify a prominent edge (e.g., the longest straight edge) of the TIM patch based, at least in part, on the contour 202. In at least one embodiment, the contour can be analyzed to identify a most probable and/or prominent edge line from the contour 202, such as by using a maximum votes process. A maximum votes process, such as may use a library such as OpenCV HoughLine or Hough Line Transform, can attempt to identify a line 212 or segment (that is to be drawn across a cropped image 210) that intersects or aligns with the most pixels of the contour. In some embodiments, for each pixel location along the contour, at least a subset of possible lines can be analyzed, a number of intersecting pixels with a line or number of pixels within a given pixel distance of a line can be determined, etc. While, in some embodiments, a set of lines may be determined that have more than a threshold number of pixel intersections, the most probable line that aligns with an edge of the TIM patch as represented by the contour 202 is determined from the set of lines. As illustrated in FIG. 2B, the line 212 identified through such a process essentially follows a primary edge of the TIM patch in the cropped image 210.

Additionally, the interior of the contour can be determined and considered as an area 222 of a binary map (or mask), as illustrated in the image view 220 of FIG. 2C. In at least one embodiment, the area within the contour can be filled using a flood fill (or similar) process, such as may use an OpenCV fillPoly-based process to determine the area 222 within the contour. In at least one embodiment, the area 222 inside the contour can be filled with pixels having the same pixel value or color, such as a value representing white or black. In such an approach, the area of the closed contour can be calculated or otherwise determined using a sum of the binary map. The area 222 corresponds to a portion of the cropped image representing the TIM patch, along with some potential additional noise or component representation. In some embodiments, the interior of the contour can be determined prior to or in parallel with identifying the primary line 212.

Once the area 222 is determined and the primary line 212 is identified, the position of the primary line 212 can be determined relative to the filled area 222. In order to simplify a search process and conserve computing or processing resources, the primary line 212 and filled area 222 can be rotated, if necessary, until the primary line 212 aligns with a primary axis of the image or coordinate system. For example, a primary axis of the image may be either vertical or horizontal in an image view. The rotation can also be performed to cause the primary line 212 to align with a row or column of pixels in the image. In this example of FIG. 2D, a vertical line (parallel to the primary line 212) can subsequently be swept or shifted across the filled area 222 to attempt to determine the opposite edge of prominent edge of the TIM patch. This vertical line can be swept from the position of the primary line or from an intersection location with a center point 232 (e.g., centroid) of the filled area 222, among other such options. Sweeping from the center point 232 can reduce the time and computations needed with respect to sweeping from the primary line 212 while producing the same results. In some embodiments, the sweeping can be performed starting from the center point of the ROI without having to perform any calculations with respect to the filled area 222. As mentioned, the sweeping direction can be orthogonal to, and away from, the primary line 212 across the filled area. The sweeping can continue until an end or edge criterion is satisfied. In at least one embodiment, this can be the position at which less than a threshold number of pixels are intersected by the line 234 being swept. For example, if the line 234 starts at the center point 232, there will be a number of pixels (e.g., 100) of the filled area intersected by the line. As the swept line gets to the edge of the TIM patch, the number of intersected pixels will drop. Once past the edge, there will be no pixels of the TIM patch intersected by the line. Accordingly, a threshold such as 50% can be set such that the location of the secondary line 234 corresponding to the opposite edge from that of the primary line or the prominent edge is the first location where the number of pixels is 50% (or less) of the pixels intersected at the center or sweep start location. In this example, this would correspond to the location where the secondary line 234 intersects 50 pixels or less, which is 50% or less of the 100 pixels intersected at the center point. Such an approach can be used to quickly determine the second edge location of the TIM patch.

A similar approach can be used to find additional edges, such as the third and fourth edges of the TIM patch, as illustrated in the example image view 240 of FIG. 2E. In some embodiments, the sweeping of the third line 242 and the sweeping of the fourth line 244 continue until the end or edge criterion is satisfied. In this example, a third line 242 (orthogonal to the primary and secondary lines) is swept from a location intersecting the center point 232 in a first direction (up in this example) parallel to the primary and secondary lines until the end or edge threshold condition is satisfied, which corresponds to the edge position of the third line 242. A fourth line 244 is swept from the location intersecting the center point 232 in a second direction (down in this example) opposite the first direction, until the end or edge threshold condition is satisfied, which corresponds to the edge position of the fourth line 244. At this point, the four lines will represent the edges of the TIM patch in the image view 240 of FIG. 2E. Intersection points 252, 254, 256, 258 of these four lines can then be determined, as illustrated in the image view 250 of FIG. 2F. These coordinates represent the coordinates of a bounding box around the TIM patch.

These points 252, 254, 256, 258 can then represent approximations of the locations of the corners of the TIM patch as represented by the contour 202 as illustrated in the image view 260 of FIG. 2G. If the cropped image and/or contour 202 was previously rotated based on the orientation of the primary line 212, such as by an angle θ, then the four points 252, 254, 256, 258 in the image view can be rotated back, such as by an angle θ, so that the four points 252, 254, 256, 258 represent approximations of the TIM patch without rotation and as represented in the original and/or cropped image, as illustrated in the image view 270 of FIG. 2H.

Once the four points 252, 254, 256, 258 (or vertices of a bounding box) are identified that represent the size and orientation of the TIM patch, the positions of those four points 252, 254, 256, 258 can be compared against a set of reference points 282, 284, 286, 288, as illustrated in the image view 280 of FIG. 2I, which may be obtained from the golden standard or golden image. The reference points 282, 284, 286, 288 represent the “ideal” locations of the corners of a TIM patch if accurately placed on the underlying physical component, such as a heat sink. The differences in position between the determined four points 252, 254, 256, 258 (e.g., x,y coordinate points) approximating the actual TIM patch and the four reference points 282, 284, 286, 288 can be analyzed to determine whether the TIM patch is acceptable, and should pass the inspection, or unacceptable, and should fail the inspection. There may be various criteria used for such evaluation. There may be an acceptable amount of deviation in any given direction for any given approximation point. There may also or alternatively be acceptable amounts of deviation in distance between any two of the approximation points, or a deviation in overall shape defined by the set of four approximation points with respect to the reference points, among other such options. There may also or alternatively be an acceptable amount of rotation of the set of four approximation points, corresponding to rotation of the TIM patch as installed with respect to the target orientation. For example, it might be determined that a TIM patch passes the inspection if none of the locations of the approximation points 252, 254, 256, 258 deviate from the expected positions defined by the reference points 282, 284, 286, 288 by more than 3 pixels in any given direction, or by more than an equivalent 2 mm in any given direction. In addition to being sufficiently accurate (within tolerance), such a process can be very fast—this process is able to be completed in less than 0.01 seconds. Such a process can accurately determine whether a TIM patch has been damaged or incorrectly applied, or is completely missing, among other potential problems.

Depending in part upon the result, a given TIM patch can be determined to pass or fail the inspection. If the results are on the borderline, indeterminable or unreliable, or do not satisfy another edge condition, then the TIM patch might be flagged for further inspection or another such action performed. In some instances, it may be determined using such an approach that an error was made in the production process, such as where a TIM patch of the wrong size was applied or a TIM patch was applied in the wrong location, among other such options. In at least one embodiment, the perimeter of a TIM patch can be calculated using the four approximated vertex points, and a determination can be made as to whether the length of the perimeter falls within the target range. In at least one embodiment, an inspection tool can be used that approximates the vertex locations of a TIM patch using an approach such as is disclosed herein, and can provide output data based in part on those vertex locations, such as may include data relating to the size, shape, and rotation of a given TIM patch (or other such component or object). A recipient (e.g., user, system component, etc.) of this information can then compare this data to a set of inspection criteria to determine whether the TIM patch passes or fails the inspection (or triggers another such outcome or result). This may include, for example, comparing the output data to values or ranges specified in an appropriate configuration file.

Although discussed with respect to TIM layers or patches applied to a component of an electrical assembly or physical component, such as a processor or heat sink, it should be understood that such approaches can be used advantageously for any object, component, member, or element that is to be placed, manufactured, or otherwise located in a specific position with a specific orientation, size, and/or shape, among other such options. While rectangular and square components are discussed herein, components may be analyzed that have other geometric (or other) shapes as well, such as where a first edge line can be located and lines swept from a center point in the corresponding directions to locate the other edges (or contour portions) of the component. As mentioned, the object or component to be analyzed can be a physical element, such as a piece of tape or portion of a material layer, or a layer or region formed from a gel or epoxy, among other such options. Further, there may be multiple such elements on a physical component to be analyzed that have different shapes or sizes, such as different types of TIM patches on a single physical assembly or component, and approaches presented herein can determine the vertex or bounding positions or coordinates separately for each of these elements, allowing for comparison against the respective criteria.

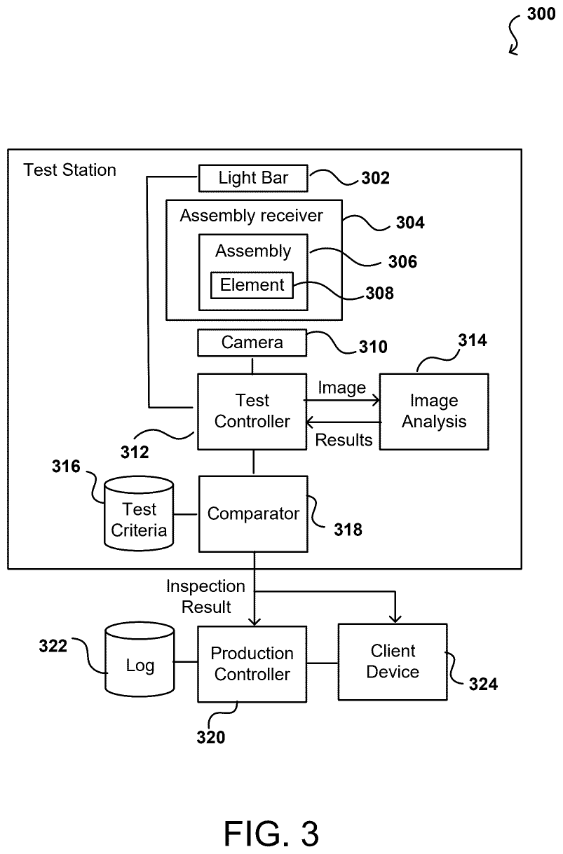

In at least one embodiment, an inspection process as presented herein can be used in a test station 300, such as that illustrated in FIG. 3. This may be a test station separate from an installation station (or other location) where an element 308, such as a TIM patch, is added to a physical component or assembly 306, as may require transitioning of the assembly 306 from the installation location to an assembly receiver 304 of the test station. In other embodiments, a test station 300 may be part of the production line and/or installation station, such that the TIM patch can be analyzed in place after installation, among other such options. In this example, a test station 300 will include at least one light source, such as a light bar 302, that can provide sufficient illumination to allow for capture of an image that accurately represents the element 308 installed on the physical assembly 306. A camera 310 (or other imaging sensor) can be positioned such that an element 308, when the attached assembly 306 is placed in the assembly receiver 304 (or at another location for inspection), is within a field of view of the camera. A test controller 312 can cause the light bar 302 to illuminate the element 308 and assembly 306 in the assembly receiver 304 and can cause the camera 310 to capture at least one image of the element 308 (or location at which the element 308 should be located given production plans). The captured image data can then be provided to the test controller 312, which can then provide the image data to an image analysis module 314 to determine information about the installed element 308. In other embodiments, the captured image data may be provided directly to the image analysis module 314, among other such options. As mentioned, other types of sensors can be used to capture other types of data representative of the location of the element, such as a LiDAR or point cloud data captured using a LiDAR system, ultrasonic sensor, laser scanner, or other such component or system.

The image analysis module 314 can perform any image pre-processing of the image that might be necessary. This may include, for example, performing cropping, resizing, noise reduction, grayscale conversion, or any other such operation deemed appropriate for the inspection. The image analysis module 314 can use a golden image, or other such information, to identify the target locations of the elements to be inspected, such as the target locations of a set of TIM patches for a given type of assembly. The image analysis can then perform analysis for the cropped images (or otherwise selected image portions) corresponding to individual elements. This may include a process such as those in the various embodiments disclosed herein. The image analysis module 314 can determine a set of approximate vertex or corner points (or other such features or aspects) of an individual element. In some embodiments the image analysis module 314 may provide coordinates of these points as output, while in at least some embodiments the image analysis module can calculate other output values as discussed and suggested herein, as may include a size, area, location, rotation, perimeter length, and the like. In this example, the image analysis module 314 will provide these results to the test controller 312, which may pass these values to a comparator 318 to determine whether these output values should result in a pass, fail, or other such determination for an individual element, or set of elements for an assembly. In other embodiments, the results may be provided directly to the comparator 318, among other such options. The comparator 318 may be a module that is part of the test station 300 or a separate component or service, such as an application hosted on a separate computing device, among other such options. In this example, the comparator 318 can compare the output values against test criteria for the type of assembly, as may be pulled from a test criteria repository 316 or other such storage location. As there may be different elements and different types of assemblies with different sizes, shapes, and configurations, it can be necessary to store multiple sets of test criteria that can be selected based on the type(s) of element, component, and/or assembly to be inspected. The comparator can compare the output values from the image analysis module 314 against the relevant test criteria to determine whether the output values fall within the expected ranges for a successful installed element. As mentioned, this may include values within expected ranges for position, rotation, size, shape, and the like. The comparator can then output its inspection result, which may be a simple pass/fail result, or may include additional or alternative information such as individual comparison data points, etc. The inspection result can be provided to at least one recipient, such as a production controller 320 that can determine whether to allow a component or assembly with all passing marks to continue along the production line, or to pull (or otherwise handle) a component or assembly from the production line that has failed at least one inspection. For a component such as a heat sink that may have a number of TIM patches, the heat sink may be able to continue with production as long as at least a minimum number (e.g., 8 or 9) of the TIM patches pass the inspection, or as long as all TIM patches are within the bounds of the heat sink even if one or more of the TIM patches fall outside the specified range of expectation. The inspection result can also be provided to a client device 324 so that a human inspector or operator can review the inspection result. In at least some embodiments a determination as to whether to pull a component or assembly from the production line based on the inspection results can be made by a human operator using the client device 324 or another such mechanism. In other embodiments, the decision may be made automatically but the results may still be provided to the client device so that a human operator can determine if there is a potential issue that should be addressed. For example, two or more elements in a row having failed for a similar reason may indicate that there is a problem with the assembly process. The inspection results, as well as information for components or assemblies pulled from production, may be stored to a data log repository 322 or other such location, which may be useful for determining installation performance and other such metrics. In at least one embodiment, the cropped image of the element being tested can also be provided for display via the client device 324, allowing a human operator (or process) to review the element for other potential defects as well, such as holes, artifacts, unexpected components, or other such deficiencies in the assembly that may not be detected by the image analysis module 314. In at least some embodiments, the image analysis module 314 might execute additional tests on a cropped image to attempt to detect at least some of these or other such deficiencies or irregularities.

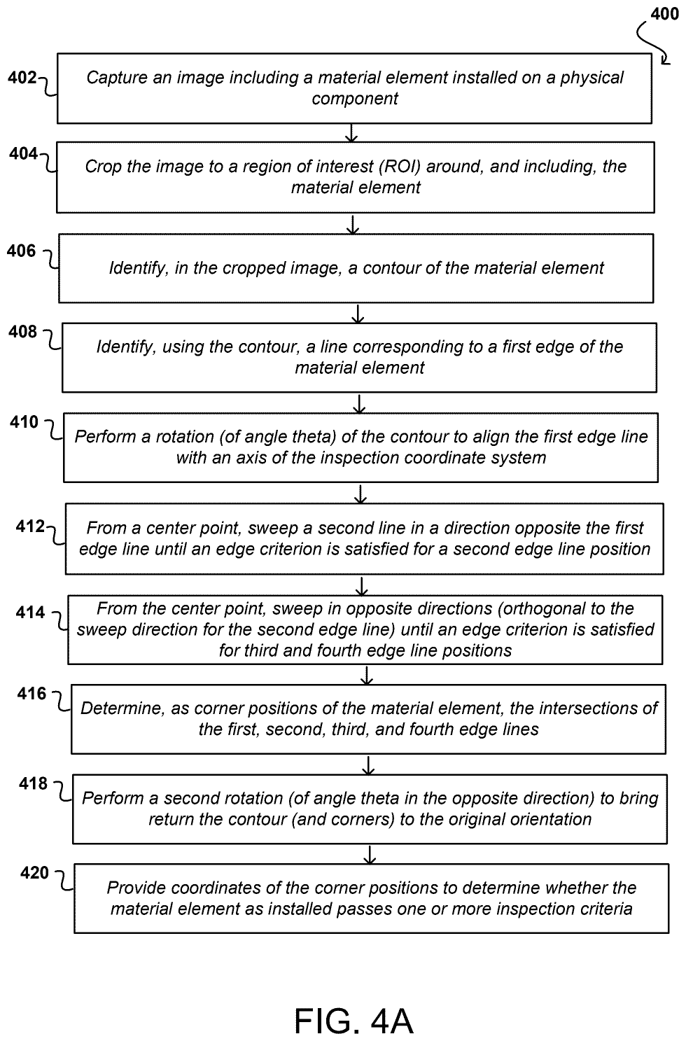

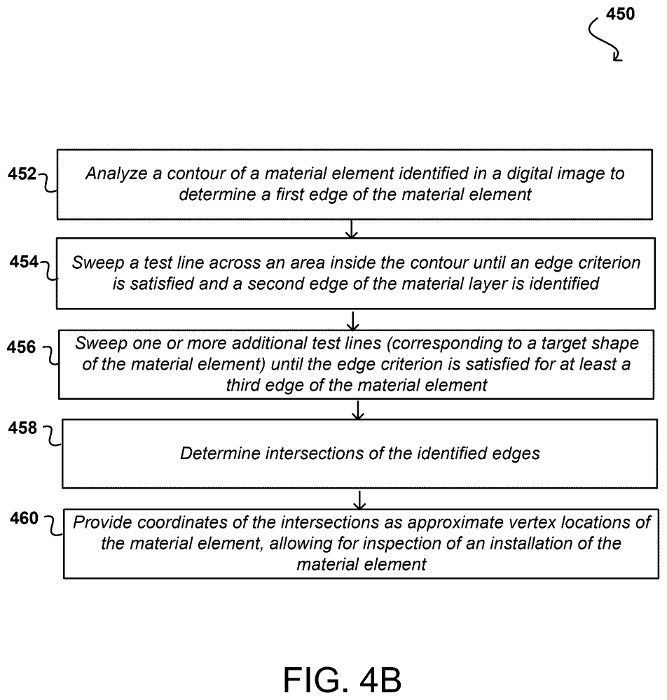

FIG. 4A illustrates an example process 400 that can be performed to determine the approximate corner positions of an installed material element, in accordance with at least one embodiment. It should be understood that for this and other processes discussed herein that there may be additional, fewer, or alternative steps performed in similar or alternative orders, or at least partially in parallel, within the scope of the various embodiments. Although discussed with respect to a material element installed on a physical component, such a process can be used to determine coordinates of other types of objects, elements, or features as well within the scope of the various embodiments. Further, although discussed with respect to installation inspection, such coordinates or positions can be used for various other purposes or operations as well. In this example process, an image is captured 402 that includes a material element installed on a physical component. In one example, this could correspond to a TIM patch attached to a heat sink or processing unit. The image can be cropped 404 (or a relevant portion of the image data selected) corresponding to a region of interest (ROI) around, and including a representation of, the material element. A contour of the material element can be identified 406 in the cropped image. Using this contour, a line corresponding to a first edge of the material element can be identified 408, such as by analyzing the number of pixels of the contour that intersect various lines across the cropped image and selecting a line that intersects the most pixels as a longest and/or most probable first edge position, among other such possible edge selection criteria. In this example, in order to reduce the computations needed and avoid unnecessary latency, a rotation (of angle theta) of the contour can be performed 410 to align the first edge line with an axis of the inspection coordinate system, such as to cause the first edge line to be vertical or horizontal, or to align with a row or column of pixels in the cropped image. If the first edge line is already within an acceptable angular range of being parallel to an axis, such as less than 1.0 degree, then it may be determined that no such rotation need be performed.

In order to help facilitate finding additional edges, a fill or flood operation can be performed using the contour to create a type of binary mask or map, where points inside the contour (and corresponding primarily to the material element) have a first value, and points outside the contour have a second value. From a center (or other such) point, such as a center point of the cropped image or a centroid of the contour, a second line can be swept 412 in a direction opposite or away from the first edge line until an edge criterion is satisfied for a second edge line position. This second edge line will be parallel to the first edge line and corresponds to an approximate second edge location of the material element that is opposite to the first edge location. For elements with other shapes, the second edge line may not be parallel to the first edge line, and the sweeping can be performed in a different direction from the center point relative to the first edge line. From the center point, two additional lines can be swept 414 in opposite directions (orthogonal to the sweep direction for the second edge line) until an edge criterion is satisfied for the third and fourth edge line positions. For other shapes, there may be additional or fewer edge lines detected as appropriate. Once all appropriate edge line positions have been detected, the intersections of the edge lines can be determined 416 as corresponding to approximate corner positions of the material element. If not all edge lines can be determined according to the appropriate criteria, then an error may be returned and the element can be determined to have failed the inspection, or another such action can be taken. If a prior rotation was performed, a second rotation can be performed 418 (of equal angle but in the opposite direction) to return the contour (and corners) to the original orientation, corresponding to the actual position of the material element. Coordinates of the corner positions after returning to the original orientation can then be provided 420, such as may be useful to determine whether the material element as installed passes or satisfies one or more inspection criteria. Other actions may be taken based on these coordinates as well, such as to calculate an amount of rotation versus expected orientation, an element perimeter length, and the like.

FIG. 4B illustrates another example process 450 that can be performed to determine approximate vertex locations of a material element in accordance with at least one embodiment. In this example, a contour of a material element (e.g., identified in a digital image or other set of sensor data) can be analyzed 452 to determine a first edge of the material element. This may include, for example, determining a line or segment through the image that intersects the most pixels of the contour (or at least the most pixels within a region of the image). A test line can be swept 454 across an area inside the contour until an edge criterion is satisfied for at least a second edge of the material element. Depending in part upon the target shape of the material element, additional test lines can be swept 456 as well until the edge criterion is satisfied for at least a third edge of the material element. Once the approximate edge locations are determined using the test lines, the intersections of these identified edges can be determined 458. The coordinates of the intersection can then be provided 460 as approximate vertex locations of the material element, or used to calculate values that can be provided, allowing for inspection of an installation of the material element, such as to determine whether the positions of the approximate vertex locations fall within one or more expected ranges or distances from the target locations from a golden standard. As mentioned, in at least one embodiment, a rotation of the image data can be performed to reduce the computational resources needed to perform the sweeps, among other potential optimizations such as region cropping, image pre-processing, and the like.

In at least some of these examples, material elements attached or connected to physical components or assemblies may be used in, or may comprise, computing and/or electronic devices that can be used to perform various operations. These can include a variety of different devices, as may include a desktop computer, notebook computer, set-top box, streaming device, gaming console, smartphone, tablet computer, VR headset, AR goggles, wearable computer, or a smart television. In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device or may incorporate one or more Virtual Machines (VMs). In at least one embodiment, such a system can be implemented at least partially in a data center or at least partially using cloud computing resources.

### Data Center

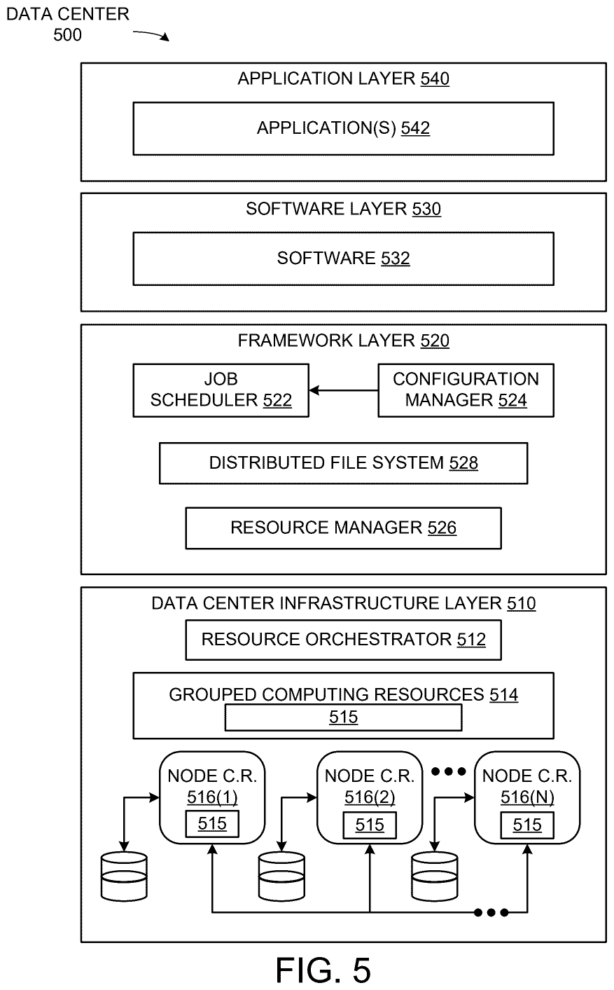

FIG. 5 illustrates an example data center 500, in which at least one embodiment may be used. In at least one embodiment, data center 500 includes a data center infrastructure layer 510, a framework layer 520, a software layer 530 and an application layer 540.

In at least one embodiment, as shown in FIG. 5, data center infrastructure layer 510 may include a resource orchestrator 512, grouped computing resources 514, and node computing resources (“node C.R.s”) 516(1)-516(N), where “N” represents a positive integer (which may be a different integer “N” than used in other figures). In at least one embodiment, node C.R.s 516(1)-516(N) may include, but are not limited to, any number of central processing units (“CPUs”) or other processors (including accelerators, field programmable gate arrays (FPGAs), graphics processors, etc.), memory storage devices 518(1)-518(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 516(1)-516(N) may be a server having one or more of above-mentioned computing resources.

In at least one embodiment, grouped computing resources 514 may include separate groupings of node C.R.s housed within one or more racks (not shown), or many racks housed in data centers at various geographical locations (also not shown). In at least one embodiment, separate groupings of node C.R.s within grouped computing resources 514 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 512 may configure or otherwise control one or more node C.R.s 516(1)-516(N) and/or grouped computing resources 514. In at least one embodiment, resource orchestrator 512 may include a software design infrastructure (“SDI”) management entity for data center 500. In at least one embodiment, resource orchestrator 512 may include hardware, software or some combination thereof.

In at least one embodiment, as shown in FIG. 5, framework layer 520 includes a job scheduler 522, a configuration manager 524, a resource manager 526 and a distributed file system 528. In at least one embodiment, framework layer 520 may include a framework to support software 532 of software layer 530 and/or one or more application(s) 542 of application layer 540. In at least one embodiment, software 532 or application(s) 542 may respectively include web-based service software or applications, such as those provided by Amazon Web Services, Google Cloud and Microsoft Azure. In at least one embodiment, framework layer 520 may be, but is not limited to, a type of free and open-source software web application framework such as Apache Spark™ (hereinafter “Spark”) that may utilize distributed file system 528 for large-scale data processing (e.g., “big data”). In at least one embodiment, job scheduler 522 may include a Spark driver to facilitate scheduling of workloads supported by various layers of data center 500. In at least one embodiment, configuration manager 524 may be capable of configuring different layers such as software layer 530 and framework layer 520 including Spark and distributed file system 528 for supporting large-scale data processing. In at least one embodiment, resource manager 526 may be capable of managing clustered or grouped computing resources mapped to or allocated for support of distributed file system 528 and job scheduler 522. In at least one embodiment, clustered or grouped computing resources may include grouped computing resources 514 at data center infrastructure layer 510. In at least one embodiment, resource manager 526 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 528 of framework layer 520. In at least one embodiment, one or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 528 of framework layer 520. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 524, resource manager 526, and resource orchestrator 512 may implement any number and type of self-modifying actions based on any amount and type of data acquired in any technically feasible fashion. In at least one embodiment, self-modifying actions may relieve a data center operator of data center 500 from making possibly bad configuration decisions and possibly avoiding underutilized and/or poor performing portions of a data center.

In at least one embodiment, data center 500 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 500. In at least one embodiment, trained machine learning models corresponding to one or more neural networks may be used to infer or predict information using resources described above with respect to data center 500 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 5 for inferencing or predicting operations based, at least in part, on weight parameters calculated using neural network training operations, neural network functions and/or architectures, or neural network use cases described herein.

Embodiments presented herein can provide for the approximation of vertex coordinates for a material element represented in captured image data, which can be useful for performing an automatic inspection of the material element.

### Computer Systems

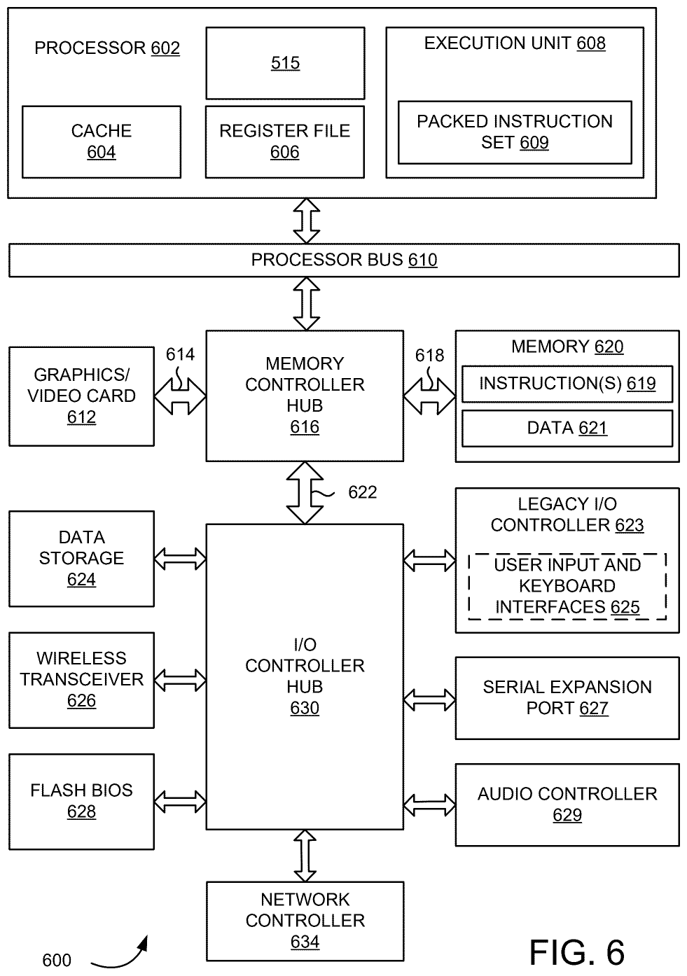

FIG. 6 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 600 may include, without limitation, a component, such as a processor 602 to employ execution units including logic to perform algorithms for process data, in accordance with present disclosure, such as in embodiment described herein. In at least one embodiment, computer system 600 may include processors, such as PENTIUM® Processor family, Xeon™, Itanium®, Scale™ and/or StrongARM™, Intel® Core™, or Intel® Nirvana™ microprocessors available from Intel Corporation of Santa Clara, California, although other systems (including PCs having other microprocessors, engineering workstations, set-top boxes and like) may also be used. In at least one embodiment, computer system 600 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“Necks”), set-top boxes, network hubs, wide area network (“WAN”) switches, or any other system that may perform one or more instructions in accordance with at least one embodiment.

In at least one embodiment, computer system 600 may include, without limitation, processor 602 that may include, without limitation, one or more execution units 608 to perform machine learning model training and/or inferencing according to techniques described herein. In at least one embodiment, computer system 600 is a single processor desktop or server system, but in another embodiment, computer system 600 may be a multiprocessor system. In at least one embodiment, processor 602 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 602 may be coupled to a processor bus 610 that may transmit data signals between processor 602 and other components in computer system 600.

In at least one embodiment, processor 602 may include, without limitation, a Level 1 (“L1”) internal cache memory (“cache”) 604. In at least one embodiment, processor 602 may have a single internal cache or multiple levels of internal cache. In at least one embodiment, cache memory may reside external to processor 602. Other embodiments may also include a combination of both internal and external caches depending on particular implementation and needs. In at least one embodiment, a register file 606 may store different types of data in various registers including, without limitation, integer registers, floating point registers, status registers, and an instruction pointer register.

In at least one embodiment, execution unit 608, including, without limitation, logic to perform integer and floating point operations, also resides in processor 602. In at least one embodiment, processor 602 may also include a microcode (“code”) read only memory (“ROM”) that stores microcode for certain macro instructions. In at least one embodiment, execution unit 608 may include logic to handle a packed instruction set 609. In at least one embodiment, by including packed instruction set 609 in an instruction set of a general-purpose processor, along with associated circuitry to execute instructions, operations used by many multimedia applications may be performed using packed data in processor 602. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 608 may also be used in microcontrollers, embedded processors, graphics devices, DSPs, and other types of logic circuits. In at least one embodiment, computer system 600 may include, without limitation, a memory 620. In at least one embodiment, memory 620 may be a Dynamic Random Access Memory (“DRAM”) device, a Static Random Access Memory (“SRAM”) device, a flash memory device, or another memory device. In at least one embodiment, memory 620 may store instruction(s) 619 and/or data 621 represented by data signals that may be executed by processor 602.

In at least one embodiment, a system logic chip may be coupled to processor bus 610 and memory 620. In at least one embodiment, a system logic chip may include, without limitation, a memory controller hub (“MCH”) 616, and processor 602 may communicate with MCH 616 via processor bus 610. In at least one embodiment, MCH 616 may provide a high bandwidth memory path 618 to memory 620 for instruction and data storage and for storage of graphics commands, data, and textures. In at least one embodiment, MCH 616 may direct data signals between processor 602, memory 620, and other components in computer system 600 and to bridge data signals between processor bus 610, memory 620, and a system I/O interface 622. In at least one embodiment, a system logic chip may provide a graphics port for coupling to a graphics controller. In at least one embodiment, MCH 616 may be coupled to memory 620 through high bandwidth memory path 618 and a graphics/video card 612 may be coupled to MCH 616 through an Accelerated Graphics Port (“AGP”) interconnect 614.

In at least one embodiment, computer system 600 may use system I/O interface 622 as a proprietary hub interface bus to couple MCH 616 to an I/O controller hub (“ICH”) 630. In at least one embodiment, ICH 630 may provide direct connections to some I/O devices via a local I/O bus. In at least one embodiment, a local I/O bus may include, without limitation, a high-speed I/O bus for connecting peripherals to memory 620, a chipset, and processor 602. Examples may include, without limitation, an audio controller 629, a firmware hub (“flash BIOS”) 628, a wireless transceiver 626, a data storage 624, a legacy I/O controller 623 containing user input and keyboard interfaces 625, a serial expansion port 627, such as a Universal Serial Bus (“USB”) port, and a network controller 634. In at least one embodiment, data storage 624 may comprise a hard disk drive, a floppy disk drive, a CD-ROM device, a flash memory device, or other mass storage device.

In at least one embodiment, FIG. 6 illustrates a system, which includes interconnected hardware devices or “chips”, whereas in other embodiments, FIG. 6 may illustrate an exemplary SoC In at least one embodiment, devices illustrated in FIG. 6 may be interconnected with proprietary interconnects, standardized interconnects (e.g., PCIe) or some combination thereof. In at least one embodiment, one or more components of computer system 600 are interconnected using compute express link (CXL) interconnects.

Inference and/or training logic 515 are used to perform inferencing and/or training operations associated with one or more embodiments. In at least one embodiment, inference and/or training logic 515 may be used in system FIG. 6 for inferencing or predicting operations based, at least in part, on weight parameters calculated using neural network training operations, neural network functions and/or architectures, or neural network use cases described herein.

Embodiments presented herein can provide for the approximation of vertex coordinates for a material element represented in captured image data, which can be useful for performing an automatic inspection of the material element.

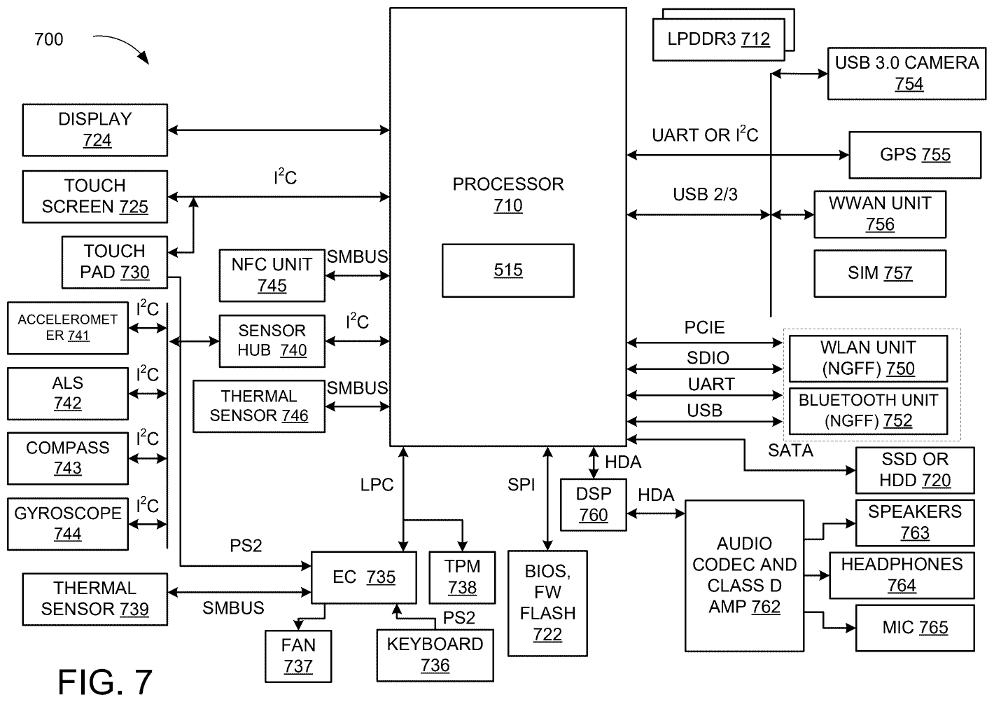

FIG. 7 is a block diagram illustrating an electronic device 700 for utilizing a processor 710, according to at least one embodiment. In at least one embodiment, electronic device 700 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 700 may include, without limitation, processor 710 communicatively coupled to any suitable number or kind of components, peripherals, modules, or devices. In at least one embodiment, processor 710 is coupled using a bus or interface, such as a I²C bus, a System Management Bus (“Sambas”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 7 illustrates a system, which includes interconnected hardware devices or “chips”, whereas in other embodiments, FIG. 7 may illustrate an exemplary SoC. In at least one embodiment, devices illustrated in FIG. 7 may be interconnected with proprietary interconnects, standardized interconnects (e.g., PCIe) or some combination thereof. In at least one embodiment, one or more components of FIG. 7 are interconnected using compute express link (CXL) interconnects.

In at least one embodiment, FIG. 7 may include a display 724, a touch screen 725, a touch pad 730, a Near Field Communications unit (“NFC”) 745, a sensor hub 740, a thermal sensor 746, an Express Chipset (“EC”) 735, a Trusted Platform Module (“TPM”) 738, BIOS/firmware/flash memory (“BIOS, FW Flash”) 722, a DSP 760, a drive 720 such as a Solid State Disk (“SSD”) or a Hard Disk Drive (“HDD”), a wireless local area network unit (“WLAN”) 750, a Bluetooth unit 752, a Wireless Wide Area Network unit (“WWAN”) 756, a Global Positioning System (GPS) unit 755, a camera (“USB 3.0 camera”) 754 such as a USB 3.0 camera, and/or a Low Power Double Data Rate (“LPDDR”) memory unit (“LPDDR3”) 715 implemented in, for example, an LPDDR3 standard. These components may each be implemented in any suitable manner.

In at least one embodiment, other components may be communicatively coupled to processor 710 through components described herein. In at least one embodiment, an accelerometer 741, an ambient light sensor (“ALS”) 742, a compass 743, and a gyroscope 744 may be communicatively coupled to sensor hub 740. In at least one embodiment, a thermal sensor 739, a fan 737, a keyboard 736, and touch pad 730 may be communicatively coupled to EC 735. In at least one embodiment, speakers 763, headphones 764, and a microphone (“mic”) 765 may be communicatively coupled to an audio unit (“audio codec and class D amp”) 762, which may in turn be communicatively coupled to DSP 760. In at least one embodiment, audio unit 762 may include, for example and without limitation, an audio coder/decoder (“codec”) and a class D amplifier. In at least one embodiment, a SIM card (“SIM”) 757 may be communicatively coupled to WWAN unit 756. In at least one embodiment, components such as WLAN unit 750 and Bluetooth unit 752, as well as WWAN unit 756 may be implemented in a Next Generation Form Factor (“NGFF”).

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

Embodiments presented herein can provide for the approximation of vertex coordinates for a material element represented in captured image data, which can be useful for performing an automatic inspection of the material element.

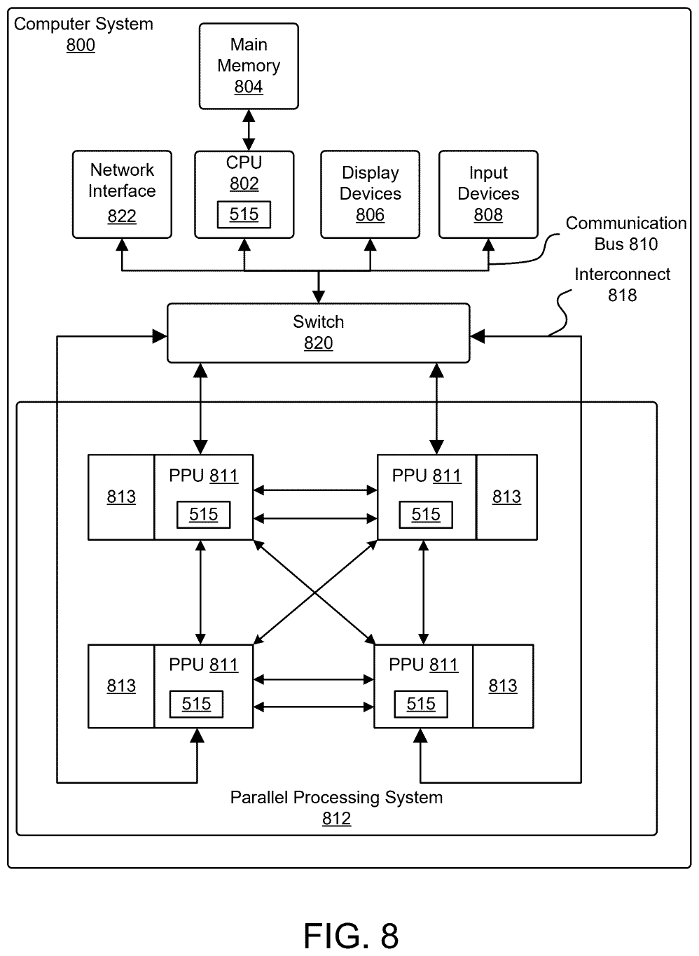

FIG. 8 illustrates a computer system 800, according to at least one embodiment. In at least one embodiment, computer system 800 is configured to implement various processes and methods described throughout this disclosure.

In at least one embodiment, computer system 800 comprises, without limitation, at least one central processing unit (“CPU”) 802 that is connected to a communication bus 810 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 800 includes, without limitation, a main memory 804 and control logic (e.g., implemented as hardware, software, or a combination thereof) and data are stored in main memory 804, which may take form of random access memory (“RAM”). In at least one embodiment, a network interface subsystem (“network interface”) 822 provides an interface to other computing devices and networks for receiving data from and transmitting data to other systems with computer system 800.

In at least one embodiment, computer system 800, in at least one embodiment, includes, without limitation, input devices 808, a parallel processing system 812, and display devices 806 that can be implemented using a conventional cathode ray tube (“CRT”), a liquid crystal display (“LCD”), a light emitting diode (“LED”) display, a plasma display, or other suitable display technologies. In at least one embodiment, user input is received from input devices 808 such as keyboard, mouse, touchpad, microphone, etc. In at least one embodiment, each module described herein can be situated on a single semiconductor platform to form a processing system.

Inference and/or training logic 515 are used to perform inferencing and/or training operations associated with one or more embodiments. In at least one embodiment, inference and/or training logic 515 may be used in system FIG. 8 for inferencing or predicting operations based, at least in part, on weight parameters calculated using neural network training operations, neural network functions and/or architectures, or neural network use cases described herein.

Embodiments presented herein can provide for the approximation of vertex coordinates for a material element represented in captured image data, which can be useful for performing an automatic inspection of the material element.

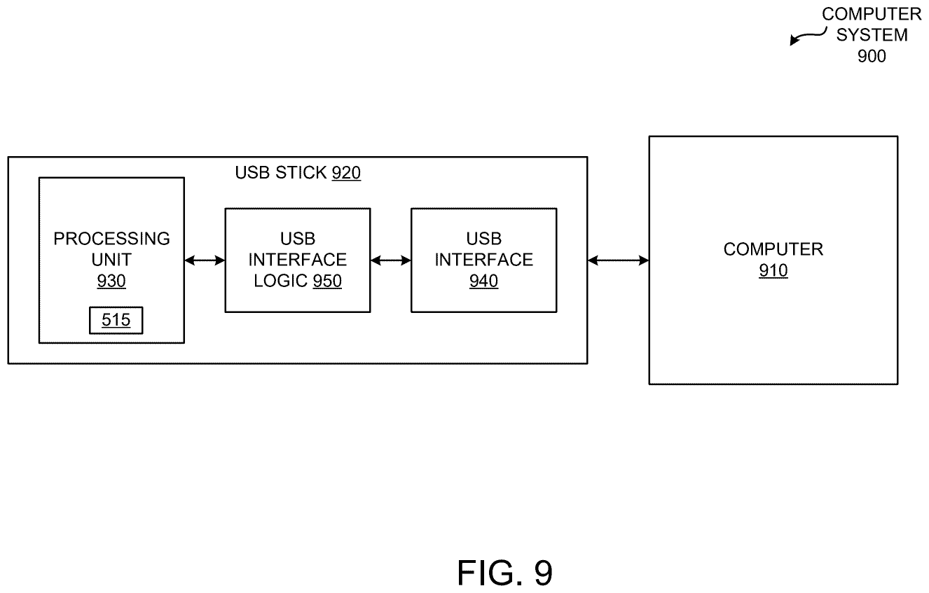

FIG. 9 illustrates a computer system 900, according to at least one embodiment. In at least one embodiment, computer system 900 includes, without limitation, a computer 910 and a USB stick 920. In at least one embodiment, computer 910 may include, without limitation, any number and type of processor(s) (not shown) and a memory (not shown). In at least one embodiment, computer 910 includes, without limitation, a server, a cloud instance, a laptop, and a desktop computer.

In at least one embodiment, USB stick 920 includes, without limitation, a processing unit 930, a USB interface 940, and USB interface logic 950. In at least one embodiment, processing unit 930 may be any instruction execution system, apparatus, or device capable of executing instructions. In at least one embodiment, processing unit 930 may include, without limitation, any number and type of processing cores (not shown). In at least one embodiment, processing unit 930 comprises an application specific integrated circuit (“ASIC”) that is optimized to perform any amount and type of operations associated with machine learning. For instance, in at least one embodiment, processing unit 930 is a tensor processing unit (“TPC”) that is optimized to perform machine learning inference operations. In at least one embodiment, processing unit 930 is a vision processing unit (“VPU”) that is optimized to perform machine vision and machine learning inference operations.

In at least one embodiment, USB interface 940 may be any type of USB connector or USB socket. For instance, in at least one embodiment, USB interface 940 is a USB 3.0 Type-C socket for data and power. In at least one embodiment, USB interface 940 is a USB 3.0 Type-A connector. In at least one embodiment, USB interface logic 950 may include any amount and type of logic that enables processing unit 930 to interface with devices (e.g., computer 910) via USB connector 940.

Inference and/or training logic 515 are used to perform inferencing and/or training operations associated with one or more embodiments. In at least one embodiment, inference and/or training logic 515 may be used in system FIG. 9 for inferencing or predicting operations based, at least in part, on weight parameters calculated using neural network training operations, neural network functions and/or architectures, or neural network use cases described herein.

Embodiments presented herein can provide for the approximation of vertex coordinates for a material element represented in captured image data, which can be useful for performing an automatic inspection of the material element.

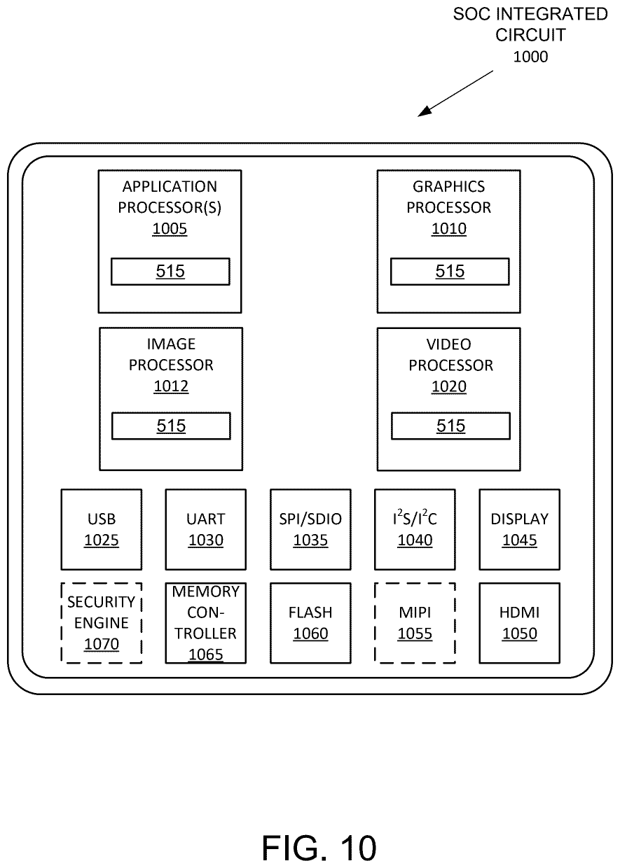

FIG. 10 illustrates exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIG. 10 is a block diagram illustrating an exemplary system-on-a-chip (SOC) integrated circuit 1000 that may be fabricated using one or more IP cores, according to at least one embodiment. In at least one embodiment, SOC integrated circuit 1000 includes one or more application processor(s) 1005 (e.g., CPUs), at least one graphics processor 1010, and may additionally include an image processor 1015 and/or a video processor 1020, any of which may be a modular IP core. In at least one embodiment, SOC integrated circuit 1000 includes peripheral or bus logic including a USB controller 1025, a UART controller 1030, an SPI/SDIO controller 1035, and an I²2S/I²2C controller 1040. In at least one embodiment, SOC integrated circuit 1000 can include a display device 1045 coupled to one or more of a high-definition multimedia interface (HDMI) controller 1050 and a mobile industry processor interface (MIPI) display interface 1055. In at least one embodiment, storage may be provided by a flash memory subsystem 1060 including flash memory and a flash memory controller. In at least one embodiment, a memory interface may be provided via a memory controller 1065 for access to SDRAM or SRAM memory devices. In at least one embodiment, some integrated circuits additionally include an embedded security engine 1070.

Inference and/or training logic 515 are used to perform inferencing and/or training operations associated with one or more embodiments. In at least one embodiment, inference and/or training logic 515 may be used in SOC integrated circuit 1000 for inferencing or predicting operations based, at least in part, on weight parameters calculated using neural network training operations, neural network functions and/or architectures, or neural network use cases described herein.

Embodiments presented herein can provide for the approximation of vertex coordinates for a material element represented in captured image data, which can be useful for performing an automatic inspection of the material element.

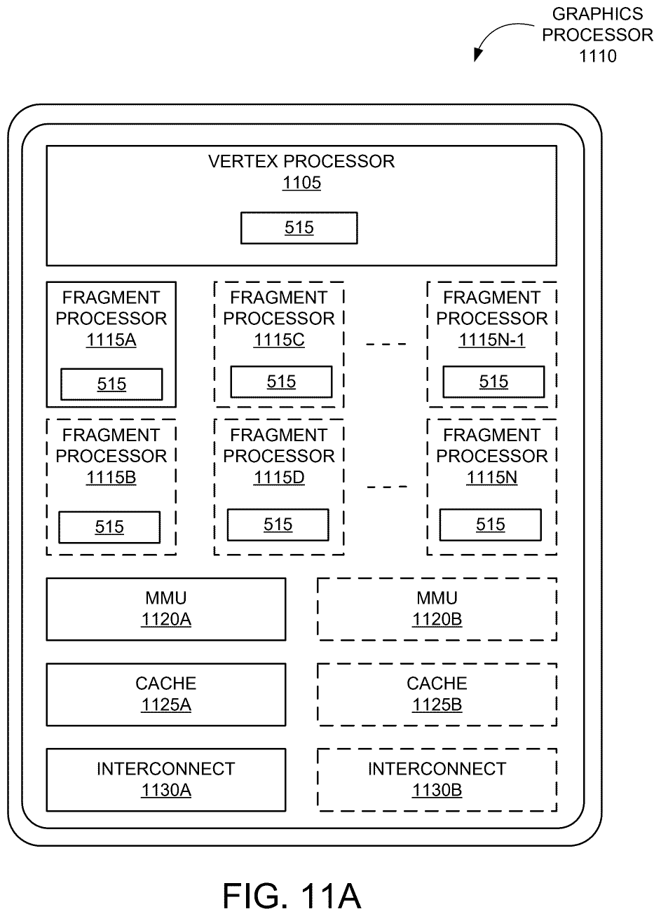

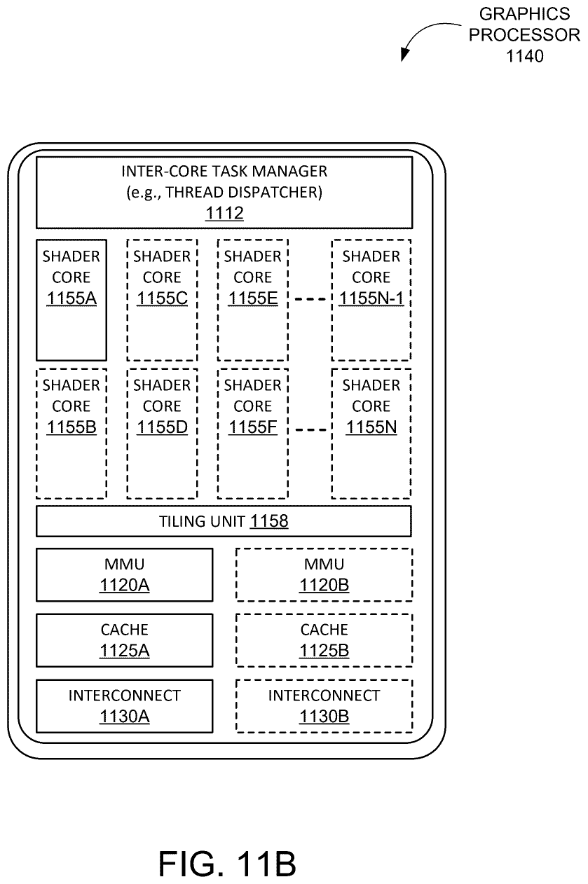

FIGS. 11A-11B illustrate exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIGS. 11A-11B are block diagrams illustrating exemplary graphics processors for use within an SoC, according to embodiments described herein. FIG. 11A illustrates an exemplary graphics processor 1110 of a system on a chip integrated circuit that may be fabricated using one or more IP cores, according to at least one embodiment. FIG. 11B illustrates an additional exemplary graphics processor 1140 of a system on a chip integrated circuit that may be fabricated using one or more IP cores, according to at least one embodiment. In at least one embodiment, graphics processor 1110 of FIG. 11A is a low power graphics processor core. In at least one embodiment, graphics processor 1140 of FIG. 11B is a higher performance graphics processor core. In at least one embodiment, each of graphics processors 1110, 1140 can be variants of computer system 900 of FIG. 9.

In at least one embodiment, graphics processor 1110 includes a vertex processor 1105 and one or more fragment processor(s) 1115A-1115N (e.g., 1115A, 1115B, 1115C, 1115D, through 1115N-1, and 1115N). In at least one embodiment, graphics processor 1110 can execute different shader programs via separate logic, such that vertex processor 1105 is optimized to execute operations for vertex shader programs, while one or more fragment processor(s) 1115A-1115N execute fragment (e.g., pixel) shading operations for fragment or pixel shader programs. In at least one embodiment, vertex processor 1105 performs a vertex processing stage of a 3D graphics pipeline and generates primitives and vertex data. In at least one embodiment, fragment processor(s) 1115A-1115N use primitive and vertex data generated by vertex processor 1105 to produce a framebuffer that is displayed on a display device. In at least one embodiment, fragment processor(s) 1115A-1115N are optimized to execute fragment shader programs as provided for in an OpenGL API, which may be used to perform similar operations as a pixel shader program as provided for in a Direct 3D API.

In at least one embodiment, graphics processor 1110 additionally includes one or more memory management units (MMUs) 1120A-1120B, cache(s) 1125A-1125B, and circuit interconnect(s) 1130A-1130B. In at least one embodiment, one or more MMU(s) 1120A-1120B provide for virtual to physical address mapping for graphics processor 1110, including for vertex processor 1105 and/or fragment processor(s) 1115A-1115N, which may reference vertex or image/texture data stored in memory, in addition to vertex or image/texture data stored in one or more cache(s) 1125A-1125B. In at least one embodiment, one or more MMU(s) 1120A-1120B may be synchronized with other MMUs within a system, including one or more MMUs associated with one or more application processor(s) 1105, image processors 1115, and/or video processors 1120 of FIG. 11A, such that each processor 1105-1120 can participate in a shared or unified virtual memory system. In at least one embodiment, one or more circuit interconnect(s) 1130A-1130B enable graphics processor 1110 to interface with other IP cores within SoC, either via an internal bus of SoC or via a direct connection.

In at least one embodiment, graphics processor 1140 includes one or more shader core(s) 1155A-1155N (e.g., 1155A, 1155B, 1155C, 1155D, 1155E, 1155F, through 1155N-1, and 1155N) as shown in FIG. 11B, which provides for a unified shader core architecture in which a single core or type or core can execute all types of programmable shader code, including shader program code to implement vertex shaders, fragment shaders, and/or compute shaders. In at least one embodiment, a number of shader cores can vary. In at least one embodiment, graphics processor 1140 includes an inter-core task manager 1145, which acts as a thread dispatcher to dispatch execution threads to one or more shader cores 1155A-1155N and a tiling unit 1158 to accelerate tiling operations for tile-based rendering, in which rendering operations for a scene are subdivided in image space, for example to exploit local spatial coherence within a scene or to optimize use of internal caches.

Embodiments presented herein can provide for the approximation of vertex coordinates for a material element represented in captured image data, which can be useful for performing an automatic inspection of the material element.

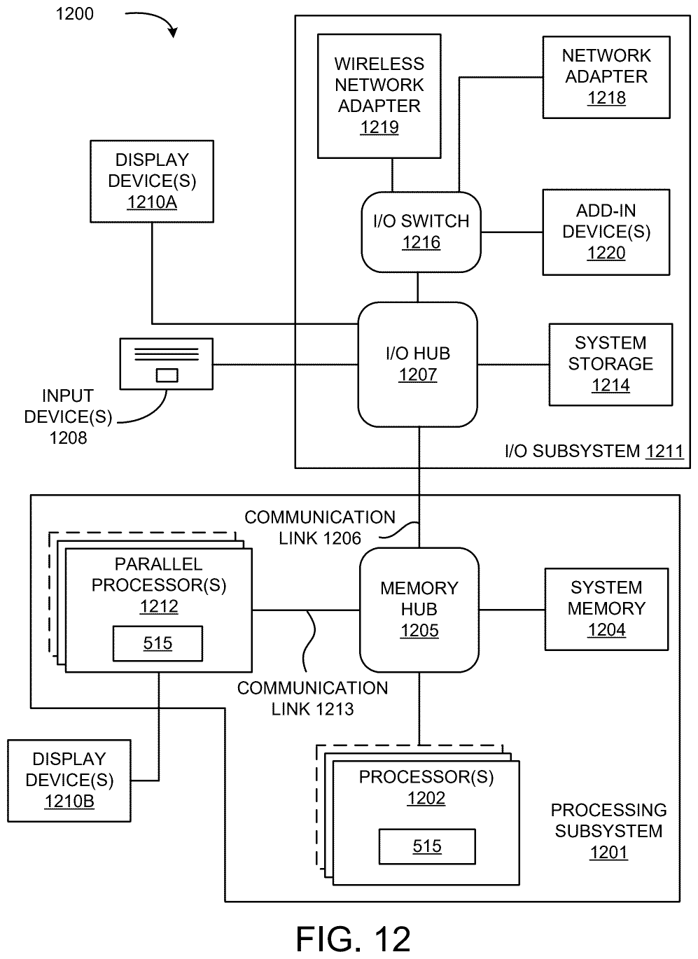

FIG. 12 is a block diagram illustrating a computing system 1200 according to at least one embodiment. In at least one embodiment, computing system 1200 includes a processing subsystem 1201 having one or more processor(s) 1202 and a system memory 1204 communicating via an interconnection path that may include a memory hub 1205. In at least one embodiment, memory hub 1205 may be a separate component within a chipset component or may be integrated within one or more processor(s) 1202. In at least one embodiment, memory hub 1205 couples with an I/O subsystem 1211 via a communication link 1206. In at least one embodiment, I/O subsystem 1211 includes an I/O hub 1207 that can enable computing system 1200 to receive input from one or more input device(s) 1208. In at least one embodiment, I/O hub 1207 can enable a display controller, which may be included in one or more processor(s) 1202, to provide outputs to one or more display device(s) 1210A. In at least one embodiment, one or more display device(s) 1210A coupled with I/O hub 1207 can include a local, internal, or embedded display device.

In at least one embodiment, processing subsystem 1201 includes one or more parallel processor(s) 1212 coupled to memory hub 1205 via a bus or other communication link 1213. In at least one embodiment, communication link 1213 may use one of any number of standards based communication link technologies or protocols, such as but not limited to PCI Express, or may be a vendor-specific communications interface or communications fabric. In at least one embodiment, one or more parallel processor(s) 1212 form a computationally focused parallel or vector processing system that can include a large number of processing cores and/or processing clusters, such as a many-integrated core (MIC) processor. In at least one embodiment, some or all of parallel processor(s) 1212 form a graphics processing subsystem that can output pixels to one of one or more display device(s) 1210A coupled via I/O hub 1207. In at least one embodiment, parallel processor(s) 1212 can also include a display controller and display interface (not shown) to enable a direct connection to one or more display device(s) 1210B. In at least one embodiment, parallel processor(s) 1212 include one or more cores, such as graphics cores 1200 discussed herein.

In at least one embodiment, a system storage unit 1214 can connect to I/O hub 1207 to provide a storage mechanism for computing system 1200. In at least one embodiment, an I/O switch 1216 can be used to provide an interface mechanism to enable connections between I/O hub 1207 and other components, such as a network adapter 1218 and/or a wireless network adapter 1219 that may be integrated into platform, and various other devices that can be added via one or more add-in device(s) 1220. In at least one embodiment, network adapter 1218 can be an Ethernet adapter or another wired network adapter. In at least one embodiment, wireless network adapter 1219 can include one or more of a Wi-Fi, Bluetooth, near field communication (NFC), or other network device that includes one or more wireless radios.

In at least one embodiment, computing system 1200 can include other components not explicitly shown, including USB or other port connections, optical storage drives, video capture devices, and like, may also be connected to I/O hub 1207. In at least one embodiment, communication paths interconnecting various components in FIG. 12 may be implemented using any suitable protocols, such as PCI (Peripheral Component Interconnect) based protocols (e.g., PCI-Express), or other bus or point-to-point communication interfaces and/or protocol(s), such as NV-Link high-speed interconnect, or interconnect protocols.

In at least one embodiment, parallel processor(s) 1212 incorporate circuitry optimized for graphics and video processing, including, for example, video output circuitry, and constitutes a graphics processing unit (GPU), e.g., parallel processor(s) 1212 includes graphics core 1200. In at least one embodiment, parallel processor(s) 1212 incorporate circuitry optimized for general purpose processing. In at least embodiment, components of computing system 1200 may be integrated with one or more other system elements on a single integrated circuit. For example, in at least one embodiment, parallel processor(s) 1212, memory hub 1205, processor(s) 1202, and I/O hub 1207 can be integrated into a system on chip (SoC) integrated circuit. In at least one embodiment, components of computing system 1200 can be integrated into a single package to form a system in package (SIP) configuration. In at least one embodiment, at least a portion of components of computing system 1200 can be integrated into a multi-chip module (MCM), which can be interconnected with other multi-chip modules into a modular computing system.

Inference and/or training logic 515 are used to perform inferencing and/or training operations associated with one or more embodiments. In at least one embodiment, inference and/or training logic 515 may be used in system FIG. 12 for inferencing or predicting operations based, at least in part, on weight parameters calculated using neural network training operations, neural network functions and/or architectures, or neural network use cases described herein.

Embodiments presented herein can provide for the approximation of vertex coordinates for a material element represented in captured image data, which can be useful for performing an automatic inspection of the material element.

### Processors

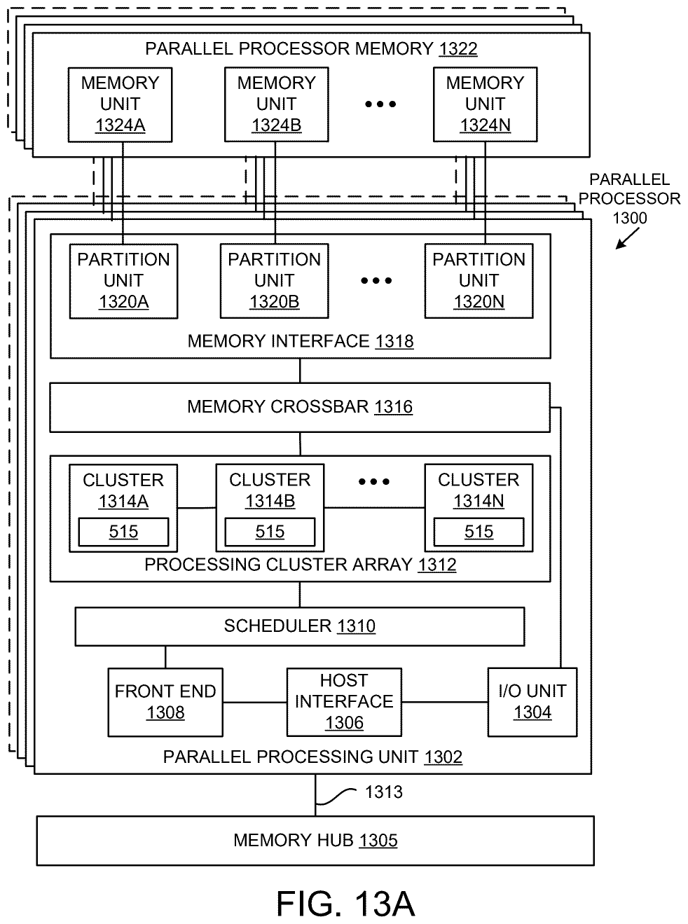

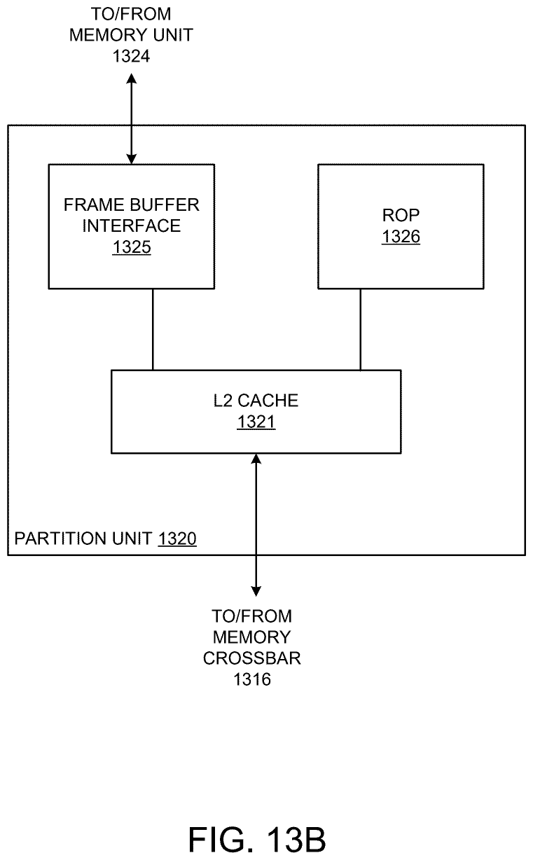

FIG. 13A illustrates a parallel processor 1300 according to at least one embodiment. In at least one embodiment, various components of parallel processor 1300 may be implemented using one or more integrated circuit devices, such as programmable processors, application specific integrated circuits (ASICs), or field programmable gate arrays (FPGA). In at least one embodiment, illustrated parallel processor 1300 is a variant of one or more parallel processor(s) 1212 shown in FIG. 12 according to an exemplary embodiment. In at least one embodiment, a parallel processor 1300 includes one or more graphics cores 1200.

In at least one embodiment, parallel processor 1300 includes a parallel processing unit 1302. In at least one embodiment, parallel processing unit 1302 includes an I/O unit 1304 that enables communication with other devices, including other instances of parallel processing unit 1302. In at least one embodiment, I/O unit 1304 may be directly connected to other devices. In at least one embodiment, I/O unit 1304 connects with other devices via use of a hub or switch interface, such as a memory hub 1305. In at least one embodiment, connections between memory hub 1305 and I/O unit 1304 form a communication link 1313. In at least one embodiment, I/O unit 1304 connects with a host interface 1306 and a memory crossbar 1313, where host interface 1306 receives commands directed to performing processing operations and memory crossbar 1316 receives commands directed to performing memory operations.

In at least one embodiment, when host interface 1306 receives a command buffer via I/O unit 1304, host interface 1306 can direct work operations to perform those commands to a front end 1308. In at least one embodiment, front end 1308 couples with a scheduler 1310 (which may be referred to as a sequencer), which is configured to distribute commands or other work items to a processing cluster array 1312. In at least one embodiment, scheduler 1310 ensures that processing cluster array 1312 is properly configured and in a valid state before tasks are distributed to a cluster of processing cluster array 1312. In at least one embodiment, scheduler 1310 is implemented via firmware logic executing on a microcontroller. In at least one embodiment, microcontroller implemented scheduler 1310 is configurable to perform complex scheduling and work distribution operations at coarse and fine granularity, enabling rapid preemption and context switching of threads executing on processing array 1312. In at least one embodiment, host software can prove workloads for scheduling on processing cluster array 1312 via one of multiple graphics processing paths. In at least one embodiment, workloads can then be automatically distributed across processing array cluster 1312 by scheduler 1310 logic within a microcontroller including scheduler 1310.

In at least one embodiment, processing cluster array 1312 can include up to “N” processing clusters (e.g., cluster 1314A, cluster 1314B, through cluster 1314N), where “N” represents a positive integer (which may be a different integer “N” than used in other figures). In at least one embodiment, each cluster 1314A-1314N of processing cluster array 1312 can execute a large number of concurrent threads. In at least one embodiment, scheduler 1310 can allocate work to clusters 1314A-1314N of processing cluster array 1312 using various scheduling and/or work distribution algorithms, which may vary depending on workload arising for each type of program or computation. In at least one embodiment, scheduling can be handled dynamically by scheduler 1310, or can be assisted in part by compiler logic during compilation of program logic configured for execution by processing cluster array 1312. In at least one embodiment, different clusters 1314A-1314N of processing cluster array 1312 can be allocated for processing different types of programs or for performing different types of computations.

In at least one embodiment, processing cluster array 1312 can be configured to perform various types of parallel processing operations. In at least one embodiment, processing cluster array 1312 is configured to perform general-purpose parallel compute operations. For example, in at least one embodiment, processing cluster array 1312 can include logic to execute processing tasks including filtering of video and/or audio data, performing modeling operations, including physics operations, and performing data transformations.

In at least one embodiment, processing cluster array 1312 is configured to perform parallel graphics processing operations. In at least one embodiment, processing cluster array 1312 can include additional logic to support execution of such graphics processing operations, including but not limited to, texture sampling logic to perform texture operations, as well as tessellation logic and other vertex processing logic. In at least one embodiment, processing cluster array 1312 can be configured to execute graphics processing related shader programs such as but not limited to, vertex shaders, tessellation shaders, geometry shaders, and pixel shaders. In at least one embodiment, parallel processing unit 1302 can transfer data from system memory via I/O unit 1304 for processing. In at least one embodiment, during processing, transferred data can be stored to on-chip memory (e.g., parallel processor memory 1322) during processing, then written back to system memory.

In at least one embodiment, when parallel processing unit 1302 is used to perform graphics processing, scheduler 1310 can be configured to divide a processing workload into approximately equal sized tasks, to better enable distribution of graphics processing operations to multiple clusters 1314A-1314N of processing cluster array 1312. In at least one embodiment, portions of processing cluster array 1312 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 1314A-1314N may be stored in buffers to allow intermediate data to be transmitted between clusters 1314A-1314N for further processing.

In at least one embodiment, processing cluster array 1312 can receive processing tasks to be executed via scheduler 1310, which receives commands defining processing tasks from front end 1308. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 1310 may be configured to fetch indices corresponding to tasks or may receive indices from front end 1308. In at least one embodiment, front end 1308 can be configured to ensure processing cluster array 1312 is configured to a valid state before a workload specified by incoming command buffers (e.g., batch-buffers, push buffers, etc.) is initiated.

In at least one embodiment, each of one or more instances of parallel processing unit 1302 can couple with a parallel processor memory 1322. In at least one embodiment, parallel processor memory 1322 can be accessed via memory crossbar 1316, which can receive memory requests from processing cluster array 1312 as well as I/O unit 1304. In at least one embodiment, memory crossbar 1316 can access parallel processor memory 1322 via a memory interface 1318. In at least one embodiment, memory interface 1318 can include multiple partition units (e.g., partition unit 1320A, partition unit 1320B, through partition unit 1320N) that can each couple to a portion (e.g., memory unit) of parallel processor memory 1322. In at least one embodiment, a number of partition units 1320A-1320N is configured to be equal to a number of memory units, such that a first partition unit 1320A has a corresponding first memory unit 1324A, a second partition unit 1320B has a corresponding memory unit 1324B, and an N-th partition unit 1320N has a corresponding N-th memory unit 1324N. In at least one embodiment, a number of partition units 1320A-1320N may not be equal to a number of memory units.

In at least one embodiment, memory units 1324A-1324N can include various types of memory devices, including dynamic random access memory (DRAM) or graphics random access memory, such as synchronous graphics random access memory (SGRAM), including graphics double data rate (GDDR) memory. In at least one embodiment, memory units 1324A-1324N may also include 3D stacked memory, including but not limited to high bandwidth memory (HBM), HBM2e, or HDM3. In at least one embodiment, render targets, such as frame buffers or texture maps may be stored across memory units 1324A-1324N, allowing partition units 1320A-1320N to write portions of each render target in parallel to efficiently use available bandwidth of parallel processor memory 1322. In at least one embodiment, a local instance of parallel processor memory 1322 may be excluded in favor of a unified memory design that utilizes system memory in conjunction with local cache memory.

In at least one embodiment, any one of clusters 1314A-1314N of processing cluster array 1312 can process data that will be written to any of memory units 1324A-1324N within parallel processor memory 1322. In at least one embodiment, memory crossbar 1316 can be configured to transfer an output of each cluster 1314A-1314N to any partition unit 1320A-1320N or to another cluster 1314A-1314N, which can perform additional processing operations on an output. In at least one embodiment, each cluster 1314A-1314N can communicate with memory interface 1318 through memory crossbar 1316 to read from or write to various external memory devices. In at least one embodiment, memory crossbar 1316 has a connection to memory interface 1318 to communicate with I/O unit 1304, as well as a connection to a local instance of parallel processor memory 1322, enabling processing units within different processing clusters 1314A-1314N to communicate with system memory or other memory that is not local to parallel processing unit 1302. In at least one embodiment, memory crossbar 1316 can use virtual channels to separate traffic streams between clusters 1314A-1314N and partition units 1320A-1320N.

In at least one embodiment, multiple instances of parallel processing unit 1302 can be provided on a single add-in card, or multiple add-in cards can be interconnected. In at least one embodiment, different instances of parallel processing unit 1302 can be configured to interoperate even if different instances have different numbers of processing cores, different amounts of local parallel processor memory, and/or other configuration differences. For example, in at least one embodiment, some instances of parallel processing unit 1302 can include higher precision floating point units relative to other instances. In at least one embodiment, systems incorporating one or more instances of parallel processing unit 1302 or parallel processor 1300 can be implemented in a variety of configurations and form factors, including but not limited to desktop, laptop, or handheld personal computers, servers, workstations, game consoles, and/or embedded systems.

FIG. 13B is a block diagram of a partition unit 1320 according to at least one embodiment. In at least one embodiment, partition unit 1320 is an instance of one of partition units 1320A-1320N of FIG. 13A. In at least one embodiment, partition unit 1320 includes an L2 cache 1321, a frame buffer interface 1325, and a ROP 1326 (raster operations unit). In at least one embodiment, L2 cache 1321 is a read/write cache that is configured to perform load and store operations received from memory crossbar 1316 and ROP 1326. In at least one embodiment, read misses and urgent write-back requests are output by L2 cache 1321 to frame buffer interface 1325 for processing. In at least one embodiment, updates can also be sent to a frame buffer via frame buffer interface 1325 for processing. In at least one embodiment, frame buffer interface 1325 interfaces with one of memory units in parallel processor memory, such as memory units 1324A-1324N of FIG. 13A (e.g., within parallel processor memory 1322).

In at least one embodiment, ROP 1326 is a processing unit that performs raster operations such as stencil, z test, blending, etc. In at least one embodiment, ROP 1326 then outputs processed graphics data that is stored in graphics memory. In at least one embodiment, ROP 1326 includes compression logic to compress depth or color data that is written to memory and decompress depth or color data that is read from memory. In at least one embodiment, compression logic can be lossless compression logic that makes use of one or more of multiple compression algorithms. In at least one embodiment, a type of compression that is performed by ROP 1326 can vary based on statistical characteristics of data to be compressed. For example, in at least one embodiment, delta color compression is performed on depth and color data on a per-tile basis.

In at least one embodiment, ROP 1326 is included within each processing cluster (e.g., cluster 1314A-1314N of FIG. 13A) instead of within partition unit 1320. In at least one embodiment, read and write requests for pixel data are transmitted over memory crossbar 1316 instead of pixel fragment data. In at least one embodiment, processed graphics data may be displayed on a display device, such as one of one or more display device(s) 1510 of FIG. 15, routed for further processing by processor(s) 1302, or routed for further processing by one of processing entities within parallel processor 1300 of FIG. 13A.

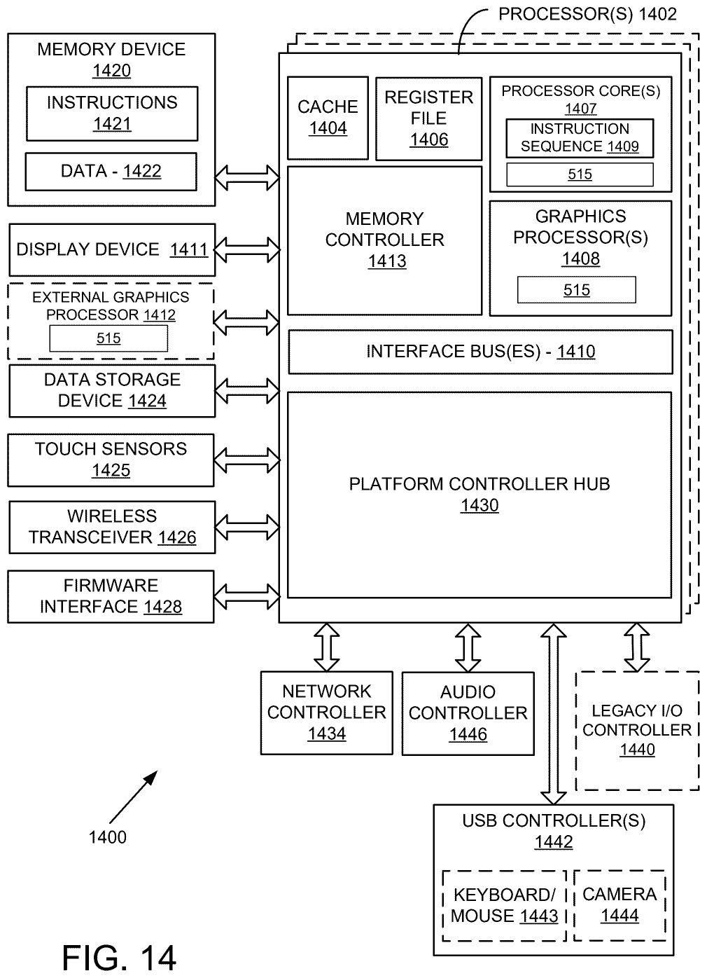

FIG. 14 is a block diagram of a processing system, according to at least one embodiment. In at least one embodiment, system 1400 includes one or more processor(s) 1402 and one or more graphics processor(s) 1408, and may be a single processor desktop system, a multiprocessor workstation system, or a server system having a large number of processor(s) 1402 or processor core(s) 1407. In at least one embodiment, system 1400 is a processing platform incorporated within a system-on-a-chip (SoC) integrated circuit for use in mobile, handheld, or embedded devices. In at least one embodiment, one or more graphics processor(s) 1408 include one or more graphics cores 1200.

In at least one embodiment, system 1400 can include, or be incorporated within a server-based gaming platform, a game console, including a game and media console, a mobile gaming console, a handheld game console, or an online game console. In at least one embodiment, system 1400 is a mobile phone, a smart phone, a tablet computing device or a mobile Internet device. In at least one embodiment, processing system 1400 can also include, couple with, or be integrated within a wearable device, such as a smart watch wearable device, a smart eyewear device, an augmented reality device, or a virtual reality device. In at least one embodiment, processing system 1400 is a television or set top box device having one or more processor(s) 1402 and a graphical interface generated by one or more graphics processor(s) 1408.

In at least one embodiment, one or more processor(s) 1402 each include one or more processor core(s) 1407 to process instructions which, when executed, perform operations for system and user software. In at least one embodiment, each of one or more processor core(s) 1407 is configured to process a specific instruction sequence 1409. In at least one embodiment, instruction sequence 1409 may facilitate Complex Instruction Set Computing (CISC), Reduced Instruction Set Computing (RISC), or computing via a Very Long Instruction Word (VLIW). In at least one embodiment, processor core(s) 1407 may each process a different instruction sequence 1409, which may include instructions to facilitate emulation of other instruction sequences. In at least one embodiment, processor core(s) 1407 may also include other processing devices, such a Digital Signal Processor (DSP).

In at least one embodiment, processor(s) 1402 includes a cache memory 1404. In at least one embodiment, processor(s) 1402 can have a single internal cache or multiple levels of internal cache. In at least one embodiment, cache memory is shared among various components of processor(s) 1402. In at least one embodiment, processor(s) 1402 also uses an external cache (e.g., a Level-3 (L3) cache or Last Level Cache (LLC)) (not shown), which may be shared among processor core(s) 1407 using known cache coherency techniques. In at least one embodiment, a register file 1406 is additionally included in processor(s) 1402, which may include different types of registers for storing different types of data (e.g., integer registers, floating point registers, status registers, and an instruction pointer register). In at least one embodiment, register file 1406 may include general-purpose registers or other registers.

In at least one embodiment, one or more processor(s) 1402 are coupled with one or more interface bus(es) 1410 to transmit communication signals such as address, data, or control signals between processor(s) 1402 and other components in system 1400. In at least one embodiment, interface bus(es) 1410 can be a processor bus, such as a version of a Direct Media Interface (DMI) bus. In at least one embodiment, interface bus(es) 1410 is not limited to a DMI bus, and may include one or more Peripheral Component Interconnect buses (e.g., PCI, PCI Express), memory busses, or other types of interface busses. In at least one embodiment processor(s) 1402 include an integrated memory controller 1416 and a platform controller hub 1430. In at least one embodiment, memory controller 1416 facilitates communication between a memory device and other components of system 1400, while platform controller hub (PCH) 1430 provides connections to I/O devices via a local I/O bus.

In at least one embodiment, a memory device 1420 can be a dynamic random access memory (DRAM) device, a static random access memory (SRAM) device, flash memory device, phase-change memory device, or some other memory device having suitable performance to serve as process memory. In at least one embodiment, memory device 1420 can operate as system memory for system 1400, to store data 1422 and instructions 1421 for use when one or more processor(s) 1402 executes an application or process. In at least one embodiment, memory controller 1416 also couples with an optional external graphics processor 1412, which may communicate with one or more graphics processor(s) 1408 in processor(s) 1402 to perform graphics and media operations. In at least one embodiment, a display device 1411 can connect to processor(s) 1402. In at least one embodiment, display device 1411 can include one or more of an internal display device, as in a mobile electronic device or a laptop device, or an external display device attached via a display interface (e.g., DisplayPort, etc.). In at least one embodiment, display device 1411 can include a head mounted display (HMD) such as a stereoscopic display device for use in virtual reality (VR) applications or augmented reality (AR) applications.

In at least one embodiment, platform controller hub 1430 enables peripherals to connect to memory device 1420 and processor(s) 1402 via a high-speed I/O bus. In at least one embodiment, I/O peripherals include, but are not limited to, an audio controller 1446, a network controller 1434, a firmware interface 1428, a wireless transceiver 1426, touch sensors 1425, a data storage device 1424 (e.g., hard disk drive, flash memory, etc.). In at least one embodiment, data storage device 1424 can connect via a storage interface (e.g., SATA) or via a peripheral bus, such as a Peripheral Component Interconnect bus (e.g., PCI, PCI Express). In at least one embodiment, touch sensors 1425 can include touch screen sensors, pressure sensors, or fingerprint sensors. In at least one embodiment, wireless transceiver 1426 can be a Wi-Fi transceiver, a Bluetooth transceiver, or a mobile network transceiver such as a 3G, 4G, or Long Term Evolution (LTE) transceiver. In at least one embodiment, firmware interface 1428 enables communication with system firmware, and can be, for example, a unified extensible firmware interface (UEFI). In at least one embodiment, network controller 1434 can enable a network connection to a wired network. In at least one embodiment, a high-performance network controller (not shown) couples with interface bus(es) 1410. In at least one embodiment, audio controller 1446 is a multi-channel high definition audio controller. In at least one embodiment, system 1400 includes an optional legacy I/O controller 1440 for coupling legacy (e.g., Personal System 2 (PS/2)) devices to system 1400. In at least one embodiment, platform controller hub 1430 can also connect to one or more Universal Serial Bus (USB) controller(s) 1442 connect input devices, such as keyboard and mouse 1443 combinations, a camera 1444, or other USB input devices.

In at least one embodiment, an instance of memory controller 1416 and platform controller hub 1430 may be integrated into a discreet external graphics processor, such as external graphics processor 1412. In at least one embodiment, platform controller hub 1430 and/or memory controller 1416 may be external to one or more processor(s) 1402. For example, in at least one embodiment, system 1400 can include an external memory controller 1416 and platform controller hub 1430, which may be configured as a memory controller hub and peripheral controller hub within a system chipset that is in communication with processor(s) 1402.

Embodiments presented herein can provide for the approximation of vertex coordinates for a material element represented in captured image data, which can be useful for performing an automatic inspection of the material element.

Various embodiments can be described by the following clauses:
1. A computer-implemented method, comprising:
analyzing a contour of a material element identified in a digital image to determine a first edge of the material element;
sweeping a test line, parallel to the first edge and in a direction orthogonal to the first edge, across an area of the material element inside the contour until at least one of an edge criterion is satisfied or a second edge of the material element is identified;
sweeping additional test lines in opposite directions, the additional test lines being orthogonal to the first and second edges and swept in directions parallel to the first and second edges, until at least one of the edge criterion is satisfied or a third edge and a fourth edge of the material element are identified;
determining coordinates of vertex locations of the material element from intersections of the first, second, third, and fourth edges; and
causing an inspection of an installation of the material element based on the coordinates.
2. The computer-implemented method of clause 1, further comprising:
rotating, in a first direction, the digital image by an angle necessary for the first edge to align with an axis of a test coordinate system before sweeping the test line; and
rotating, in a second direction opposite the first direction by the angle, the digital image before the coordinates of the vertex locations of the material element are determined.
3. The computer-implemented method of clause 1, further comprising:
receiving a first image including representations of multiple instances of the material element installed on a physical component; and
cropping the first image to a region proximate the material element to generate the digital image.
4. The computer-implemented method of clause 3, wherein the physical component is a heat sink or a printed circuit board assembly (PCBA).
5. The computer-implemented method of clause 3, wherein the multiple instances of the material element correspond to patches of a thermal interface material (TIM) installed at determined locations with respect to the physical component.
6. The computer-implemented method of clause 3, further comprising:
capturing the first image using a camera and a light bar of a workstation; and
providing data representing a golden standard including target material element placement for cropping the first image.
7. The computer-implemented method of clause 6, further comprising:
comparing the vertex locations of the material element against the data representing the golden standard as part of the inspection of the installation.
8. The computer-implemented method of clause 1, further comprising:
filling an inner region defined by the contour with pixels of a determined pixel value to generate the area of the material element, wherein the edge criterion corresponds to a number of pixels having the determined pixel value being less than a threshold number or percentage of pixels with respect to a maximum number of pixels identified during a sweep.
9. The computer-implemented method of clause 1, wherein the inspection includes determining whether the coordinates of the vertex locations fall within an expected range of coordinate positions.
10. At least one processor, comprising:
processing circuitry to perform operations comprising:
   analyzing a contour of a physical element identified in a digital image to determine a first edge of the physical element;
   sweeping a test line across an area of the physical element inside the contour until at least one of an edge criterion is satisfied or a second edge of the physical element is identified;
   sweeping additional test lines in one or more additional directions until at least the edge criterion is satisfied or at least one additional edge of the physical element is identified;
   determining intersections of the first edge, the second edge, and the at least one additional edge to obtain coordinates corresponding to the intersections; and
   causing an automatic inspection of the physical element based on the coordinates corresponding to the intersections.
11. The at least one processor of clause 10, wherein the operations further comprise:
rotating, in a first direction, the digital image by an angle necessary for the first edge to align with an axis of a test coordinate system before sweeping the test line; and
rotating, in a second direction opposite the first direction by the angle, the digital image before the coordinates corresponding to the intersections are obtained.
12. The at least one processor of clause 10, wherein the operations further comprise:
receiving a first image including representations of multiple instances of the physical element installed on an assembly; and
cropping the first image to a region proximate the physical element to generate the digital image to be analyzed.
13. The at least one processor of clause 10, wherein the operations further comprise:
capturing the first image using a camera and a light bar of a workstation;
providing data representing a golden standard including target material element placement for cropping the first image; and
comparing the vertex locations of the material element against the data representing the golden standard as part of the inspection of the physical element.
14. The at least one processor of clause 10, wherein the operations further comprise:
filling an inner region defined by the contour with pixels of a determined pixel value to determine the area of the physical element, wherein the edge criterion corresponds to a number of pixels having the determined pixel value being less than a threshold number or percentage of pixels with respect to a maximum number of pixels identified during a sweep.
15. The at least one processor of clause 10, wherein the processing circuitry is contained in a system including at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system for performing generative AI operations using a vision language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or a system implemented at least partially using cloud computing resources.
16. A system, comprising:
one or more processors to automatically inspect installation of a material element on a physical component by, in part, determining a first edge of the material element based on a contour of the material element identified in a captured image, determining other edges of the material element by sweeping across an area defined by the contour until at least one edge criterion is satisfied, and determining vertex locations of the material element corresponding to intersections of the first edge and the other edges of the material element.
17. The system of clause 16, wherein the one or more processors are further to:
rotate, in a first direction, the digital image by an angle necessary for the first edge to align with an axis of a test coordinate system before sweeping the test line; and
rotate, in a second direction opposite the first direction by the angle, the digital image before the coordinates of the intersections are determined.
18. The system of clause 16, wherein the one or more processors are further to:
receive a first image including representations of multiple instances of the material element installed on an assembly; and
crop the first image to a region proximate the material element to generate the digital image.
19. The system of clause 16, wherein the one or more processors are further to:
fill an inner region defined by the contour with pixels of a determined pixel value to determine the area of the material element, wherein the edge criterion corresponds to a number of pixels having the determined pixel value being less than a threshold number or percentage of pixels with respect to a maximum number of pixels identified during a sweep.
20. The system of clause 16, wherein the system is at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system for performing generative AI operations using a vision language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising:
analyzing a contour of a material element identified in a digital image to determine a first edge of the material element;
sweeping a test line, parallel to the first edge and in a direction orthogonal to the first edge, across an area of the material element inside the contour until at least one of an edge criterion is satisfied or a second edge of the material element is identified;
sweeping additional test lines in opposite directions, the additional test lines being orthogonal to the first and second edges and swept in directions parallel to the first and second edges, until at least one of the edge criterion is satisfied or a third edge and a fourth edge of the material element are identified;
determining coordinates of vertex locations of the material element from intersections of the first, second, third, and fourth edges; and
causing an inspection of an installation of the material element based on the coordinates.

2. The computer-implemented method of claim 1, further comprising:
rotating, in a first direction, the digital image by an angle necessary for the first edge to align with an axis of a test coordinate system before sweeping the test line; and
rotating, in a second direction opposite the first direction by the angle, the digital image before the coordinates of the vertex locations of the material element are determined.

3. The computer-implemented method of claim 1, further comprising:
receiving a first image including representations of multiple instances of the material element installed on a physical component; and
cropping the first image to a region proximate the material element to generate the digital image.

4. The computer-implemented method of claim 3, wherein the physical component is a heat sink or a printed circuit board assembly (PCBA).

5. The computer-implemented method of claim 3, wherein the multiple instances of the material element correspond to patches of a thermal interface material (TIM) installed at determined locations with respect to the physical component.

6. The computer-implemented method of claim 3, further comprising:
capturing the first image using a camera and a light bar of a workstation; and
providing data representing a golden standard including target material element placement for cropping the first image.

7. The computer-implemented method of claim 6, further comprising:
comparing the vertex locations of the material element against the data representing the golden standard as part of the inspection of the installation.

8. The computer-implemented method of claim 1, further comprising:
filling an inner region defined by the contour with pixels of a determined pixel value to generate the area of the material element, wherein the edge criterion corresponds to a number of pixels having the determined pixel value being less than a threshold number or percentage of pixels with respect to a maximum number of pixels identified during a sweep.

9. The computer-implemented method of claim 1, wherein the inspection includes determining whether the coordinates of the vertex locations fall within an expected range of coordinate positions.

10. At least one processor, comprising:
processing circuitry to perform operations comprising:
analyzing a contour of a physical element identified in a digital image to determine a first edge of the physical element;
sweeping a test line across an area of the physical element inside the contour until at least one of an edge criterion is satisfied or a second edge of the physical element is identified;
sweeping additional test lines in one or more additional directions until at least the edge criterion is satisfied or at least one additional edge of the physical element is identified;
determining intersections of the first edge, the second edge, and the at least one additional edge to obtain coordinates corresponding to the intersections; and
causing an automatic inspection of the physical element based on the coordinates corresponding to the intersections.

11. The at least one processor of claim 10, wherein the operations further comprise:
rotating, in a first direction, the digital image by an angle necessary for the first edge to align with an axis of a test coordinate system before sweeping the test line; and
rotating, in a second direction opposite the first direction by the angle, the digital image before the coordinates corresponding to the intersections are obtained.

12. The at least one processor of claim 10, wherein the operations further comprise:
receiving a first image including representations of multiple instances of the physical element installed on an assembly; and
cropping the first image to a region proximate the physical element to generate the digital image to be analyzed.

13. The at least one processor of claim 10, wherein the operations further comprise:
capturing the first image using a camera and a light bar of a workstation;
providing data representing a golden standard including target material element placement for cropping the first image; and
comparing the vertex locations of the material element against the data representing the golden standard as part of the inspection of the physical element.

14. The at least one processor of claim 10, wherein the operations further comprise:
filling an inner region defined by the contour with pixels of a determined pixel value to determine the area of the physical element, wherein the edge criterion corresponds to a number of pixels having the determined pixel value being less than a threshold number or percentage of pixels with respect to a maximum number of pixels identified during a sweep.

15. The at least one processor of claim 10, wherein the processing circuitry is contained in a system including at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system for performing generative AI operations using a vision language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.

16. A system, comprising:
one or more processors to automatically inspect installation of a material element on a physical component by, in part, determining a first edge of the material element based on a contour of the material element identified in a captured image, determining other edges of the material element by sweeping across an area defined by the contour until at least one edge criterion is satisfied, and determining vertex locations of the material element corresponding to intersections of the first edge and the other edges of the material element.

17. The system of claim 16, wherein the one or more processors are further to:
rotate, in a first direction, the digital image by an angle necessary for the first edge to align with an axis of a test coordinate system before sweeping the test line; and
rotate, in a second direction opposite the first direction by the angle, the digital image before the coordinates of the intersections are determined.

18. The system of claim 16, wherein the one or more processors are further to:
receive a first image including representations of multiple instances of the material 2 element installed on an assembly; and
crop the first image to a region proximate the material element to generate the digital image.

19. The system of claim 16, wherein the one or more processors are further to:
fill an inner region defined by the contour with pixels of a determined pixel value to determine the area of the material element, wherein the edge criterion corresponds to a number of pixels having the determined pixel value being less than a threshold number or percentage of pixels with respect to a maximum number of pixels identified during a sweep.

20. The system of claim 16, wherein the system is at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system for performing generative AI operations using a vision language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.
